(19) United States
(12) Patent Application Publication
(10) Pub. No.: US 2024/0224994 A1
(43) Pub. Date: Jul. 11, 2024

(54) INSECT REPELLANT FORMULATION AND METHOD OF USING SAME

(71) Applicants: United Industries Corporation, Earth City, MO (US); ROSS LIFESCIENCE PRIVATE LIMITED, Bhosari, Pune (IN)

(72) Inventors: Hemant S. Betrabet, Earth City, MO (US); Amber Martin, Earth City, MO (US); Josh Matta, Earth City, MO (US); Gopal P. Ananth, Maharashtra (IN); Kedar Deobhankar, Maharashtra (IN); Manju Philip, Maharashtra (IN)

(21) Appl. No.: 18/563,275

(22) PCT Filed: May 26, 2022
(86) PCT No.: PCT/US2022/031187

§ 371 Date: Nov. 21, 2023

Related U.S. Application Data
(60) Provisional application No. 63/194,509, filed on May 28, 2021.

(51) Int. Cl. A01N 35/06; A01P 17/00

(52) U.S. Cl. CPC A01N 35/06; A01P 17/00

(57) ABSTRACT

The present disclosure provides nootkatone-containing compositions and methods of using the same for repelling bugs or insects. A bug or insect repellent composition comprises nootkatone or an analogue or derivative thereof; and a carrier. The composition can further include a dispersing agent, a solvent, a synergist or functional enhancer, and/or other functional ingredient. A method of repelling insects and bugs comprises applying the composition according to the present disclosure to a subject, surface, substrate, space, or a location, whereby the insects or bugs are repelled or prevented from attaching thereto.

### CROSS REFERENCE TO RELATED APPLICATION

This application is being filed on May 26, 2022, as a PCT International Patent Application that claims priority to and the benefit of U.S. Provisional Application No. 63/194,509, filed on May 28, 2021, which application is hereby incorporated herein by reference.

### INTRODUCTION

Bug or insect repellent compositions and, in particular, compositions containing nootkatone and/or a derivative or analog thereof, alone or in combination with one or more active or functional components are provided. Methods of formulating and using the compositions are provided.

Insect repellents are widely used throughout the United States and the world. In some regions, the use of repellents is important for avoiding or reducing the occurrence of diseases carried by insects and ticks. For example, the Centers for Disease Control (CDC) receives nearly 10,000 reports of Lyme disease (transmitted by deer ticks) and 1,000 reports of encephalitis (transmitted by mosquitoes) annually.

Currently, the most common repellent is N,N-diethyl-meta-toluamide (DEET). DEET was designed to be applicable to the skin of subjects, and is designed to repel rather than kill insects and ticks. Although in use for some time, concern has recently emerged about the potential toxicity of DEET to children. Recently the US Environmental Protection Agency (EPA) determined that it would no longer allow child safety claims on labels for DEET-containing products.

In addition to DEET, examples of compounds that have been used to repel or kill insects include synthetic pyrethroids such as permethrin, carbamates, and chlorinated hydrocarbons such as lindane. However, there is a movement towards more natural alternatives and away from synthetic pesticides and repellents, with the perception being natural products are safer to use and may have more desired effects. In addition, application of such synthetic insecticide directly on human body could cause uncomfortable or unfavorable reaction.

Alternative insecticides or insect repellent products have been developed. However, many are considerably expensive and not effective as expected under some circumstances. In particular, during outdoor activities such as camping, hunting, logging, or other adventuring or recreational activities in grassland, woods, pond, lake, forest, or wild, insect repellent is always demanded in large quantity. However, many products have only limited efficiency and duration, especially against outdoor insects such as ticks and lice. Such low efficiency, insufficient effectiveness, and repeated application of insect repellents often cause significant inconvenience and dissatisfaction to consumers.

US 20150250166 to Goldblum discloses pest repellent and pesticide compositions containing nootkatone and/or a derivative or analog thereof.

US20190069542 to Julien discloses methods for repelling and killing ticks as well as for detaching attached and feeding ticks from the skin of a subject by application of a composition comprising nootkatone to the tick.

US 20200093123 to Bradbury discloses the use of emulsions or micro-emulsions containing nootkatone to repel, knock-down, and/or kill mosquitoes.

In spite of the above disclosures, it is still highly desirable for insect repellents having lower cost, low toxicity, natural ingredients, longer duration, and improved efficiency. It is further desirable for insect repellents that are environmentally- and consumer-friendly. It is against the above background the present disclosure provides advantages and advancements.

### SUMMARY OF DISCLOSURE

In one aspect, the present disclosure is related to a bug or insect repellent composition. The composition comprises nootkatone or an analogue or derivative thereof; and a carrier.

In some embodiments, the composition further comprises a dispersing agent. The dispersing agent may provide multiple benefits or useful functions. For example, the dispersing agent may play a role of viscosity modification/adjustment. When the composition is applied to a subject, the dispersing agent may facilitate uniform application and formation of an even layer or film of nootkatone on targeted surface of the subject. The dispersing agent may also enhance the stability and duration of nootkatone that is applied onto the targeted surface, preventing it from evaporation or deterioration too fast. The dispersing agent may be a consumer-friendly or skin-caring material that is healthy, neutral, and not too greasy or oily. In some embodiments, the dispersing agent may be a polymeric material including but not limited poly(vinyl pyrrolidone), polyacry late, poly(acrylic acid), poly(ethylene glycol), poly(vinyl alcohol), poly(vinyl acetate), polyacry late carboxy late copolymer, styrene acrylic acid copolymer, alkyl-polyglucoside, and combinations thereof in any proportion. In certain embodiments, the dispersing agent consists essentially of poly (vinyl pyrrolidone).

In some embodiments, the composition further comprises a solvent (dissolution agent). The solvent may enhance the solubility of nootkatone in the composition, prolong the stability and durability of the composition, improve the effectiveness of nootkatone when use, and/or prevent unfavorable settlement or precipitation. In some embodiments, the solvent may be potent, aromatic solvent including but not limited to benzyl alcohol, diethyl phthalate, butyl phthalate, and combinations thereof in any proportion. In certain embodiments, the solvent consists essentially of benzyl alcohol. In some embodiments, the carrier is an alcohol including but is not limited to 1-propanol, 2-propanol (isopropyl alcohol), 1-butanol, 2-butanol, 2-methyl-1-propanol, 1-pentanol, 2-pentanol, 3-methyl-1-butanol, 3-methyl-2-butanol, ethylene glycol, propylene glycol, 1,4-butanediol, 1,3-butanediol, and combinations thereof in any proportion. In certain embodiments, the solvent consists essentially of isopropyl alcohol.

In some embodiments, the composition further comprises an essential oil that provides beneficial functions such as anti-bacteria, anti-fungal, anti-microbial, heat-relief, pain-relief, or skin-care. In some embodiments, the essential oil can serve as a synergist or functional enhancer described herein. In some embodiments, the essential oil include but is not limited to cuminaldehyde, cinnamaldehyde, cinnamic alcohol, carvacrol, carveol, citral, citronellal, citronellol, thyme oil, thymol lavender oil, rosemary oil, peppermint oil, neem oil, lemongrass oil, wintergreen oil, clove extract, metabolites of trans-anethole, vanillin, ethyl vanillin, and combinations thereof in any proportion.

In some embodiments, the composition further comprises a fragrance or flavor substance or an agent imparting a pleasant odor. Non-limiting examples of fragrance agent or agents imparting a pleasant odor include fruit ester, damascenone, alpha-ionone, beta-ionone, raspberry ketone, furanone derivative, limonene, linalool, phenylacetaldehyde, 2-phenylethanol, maltol, vanillin, eugenol, anethol, anise alcohol, anisaldehyde, guajakol, cinnamyl alcohol, cinnamaldehyde, citral, citronellal, citronellol, nerol, geraniol, ethylvanillin, benzyl alcohol, anisaldehyde, cinnamyl ester, benzyl ester, damascone, diacetyl, dihydrocoumarin, beta-dihydroionone, dimethyl anthranilate, methyl anthranilate, ethylmaltol, heliotropin, cis-3-hexenyl ester, ethyl decadienoate, methyl dihydrojasmorvate, methyl cinnamate, ethyl cinnamate, p-mentha-8-thiol-3-one, rose oxide, ketoisophorone, and combinations thereof in any proportion.

In some embodiments, the present composition further comprises one or more synergist or functional enhancer selected from the group comprising p-menthane-3,8-diol (PMD), vanillin, Eugenol, Citral, linalool, terpene-oil or terpene derivatives, cuminaldehyde, thyme oil, clove oil, oil of Lemon Eucalyptus (OLE), and combinations thereof in any proportion.

In some embodiments, the composition further comprises a surfactant.

In some embodiments, the composition is non-aqueous, or free or substantially free from water.

In some embodiments, the composition is not an emulsion, and is substantially free from an emulsifier.

In some embodiments, the composition is a clear or substantially clear liquid, with a turbidity value of about 30 NTU or less, about 20 NTU or less, about 10 NTU or less, about 5 NTU or less, or about 1 NTU or less, wherein, NTU represents Nephelometric Turbidity Units.

In some embodiments, the composition is free or substantially free from N, N-diethyl-m-toluamide (DEET).

In some embodiments of the present composition, the nootkatone may have a content from about 0.1 wt % to about 20 wt %, or from about 1 wt % to about 18 wt %, or from about 2 wt % to about 16 wt %, or from about 3 wt % to about 14 wt %, or from about 4 wt % to about 12 wt %, or from about 5 wt % to about 10 wt %, or from about 6 wt % to about 8 wt %, based on the total weight of the composition. The dispersing agent may have a content from about 0.1 wt % to about 10 wt %, or from about 0.5 wt % to about 8 wt %, or from about 1 wt % to about 6 wt %, or from about 1.5 wt % to about 5 wt %, or from about 2 wt % to about 4 wt %. The solvent may have a content of at least about 60 wt %, or at least about 50 wt %, or at least about 40 wt %, or at least about 30 wt %, or at least about 20 wt %, or from about 0.1 wt % to about 20 wt %, or from about 1 wt % to about 12 wt %, or from about 2 wt % to about 8 wt %, or from about 3 wt % to about 7 wt %, or from about 4 wt % to about 6 wt %, based on the total weight of the composition. The essential oil compound has a content from about 0 wt % to about 20 wt %, or from about 1 wt % to about 12 wt %, or from about 2 wt % to about 8 wt %, or from about 3 wt % to about 7 wt %, or from about 4 wt % to about 6 wt %, based on the total weight of the composition. The flavor substance may have a content from about 0 wt % to about 20 wt %, or from about 1 wt % to about 12 wt %, or from about 2 wt % to about 8 wt %, or from about 3 wt % to about 7 wt %, or from about 4 wt % to about 6 wt %, based on the total weight of the composition.

In some embodiments, a bug or insect repellent composition consists essentially of: from about 1 wt % to about 10 wt % of nootkatone; from about 1 wt % to about 20 w1% of a solvent; from about 1 wt % to about 10 wt % of a dispersing agent; and from about 60 wt % to about 97 wt % of a carrier. The solvent, dispersing agent, and the carrier are in accordance with the description provided in the present disclosure.

In some embodiments, a bug or insect repellent composition consists essentially of: from about 1 wt % to about 10 wt % of nootkatone; from about 1 wt % to about 20 wt % of a solvent; from about 1 wt % to about 10 wt % of a dispersing agent; or from about 1 wt % to about 20 wt % of a synergist or functional enhancer, and from about 40 wt % to about 96 wt % of a carrier. The solvent, dispersing agent, and the carrier are in accordance with the description provided in the present disclosure.

In certain embodiments, a bug or insect repellent composition consists essentially of: from about 3 wt % to about 7 wt % of nootkatone; from about 4 wt % to about 12 wt % of benzyl alcohol; from about 1 wt % to about 5 wt % of poly(vinyl pyrrolidone); and from about 76 wt % to about 92 wt % of isopropyl alcohol.

In another aspect, the present disclosure provides a method of repelling an insect. The method comprises applying any one of the composition described herein on a surface, whereby the insect is repelled from attaching to the surface.

In some embodiments, the present composition may be used to repel a bug or insect. Non-limiting examples of the bug or insect include a nematode, a mosquito, a gnat, a horse fly, a tick, a tsetse fly, a blowfly, a screw fly, a bed bug, a flea, a louse, a sea louse, an fish louse, an aphid, a thrip, an arachnid, a termite, a silverfish, an ant, a cockroach, a locust, a fruit fly, a wasp, a hornet, a yellow jacket, a scorpion, a chigger, a mite, or a dust mite.

In some embodiments, the present composition may be applied to a surface, wherein the bug or insect is repelled or prevented from attaching to the surface. Non-limiting examples of the surface include a plant, a portion of a plant, a harvested plant material, an exterior surface of a human body, an exterior surface of an animal body, skin, hair, fur, scales, feathers, an article of clothing, a collar, a shoe, furniture, bedding, a net, a table, a bench, a desk, a pathway, a carpet, a floor board, a head board, a curtain, a window sill, a mantelpiece, a work surface, a door, a wall molding, a wall, a sheet of glass, or any surface of a vehicle, a tent, a wall, a floor, a waste bin, or a water surface.

In some embodiments, the present composition may be used by applying the composition to a target subject or surface or space or area. Application of the present composition may be carried out by an aerosol container with a spray nozzle, a spray gun, a pump sprayer, a trigger sprayer, a pressurized spraying device, a sponge, a brush, a roller, an irrigation spray, or a crop duster helicopter or airplane.

In another aspect, the present disclosure relates to a personal care or skin care or cosmetic product based on the present composition. For example, a composition comprising a mixture of nootkatone and/or a derivative or analog thereof to a carrier, such as an alcohol, aldehyde, ketone, ester, oil or ether or combinations thereof, can be prepared and added to a standard personal care or cosmetic formulation to deliver the nootkatone and/or a derivative or analog thereof. Representative formulations to which the nootkatone and/or a derivative or analog thereof can be added include insect repellents, skin care products, hair care products, and cleansing products.

The present composition may be used to repel the bug or insect, cause knock-down of the bug or insect, paralyzes the bug or insect, inactivate or immobilize the bug or insect, kills the bug or insect, or cause a lack of progression into at least one stage of the life cycle of the bug or insect.

In some embodiments, the present disclosure relates to a method of repelling a tick from attaching to human skin, the method comprises applying a composition to a surface of the human skin, wherein the composition consists essentially of: from about 3 wt % to about 7 wt % of nootkatone; from about 4 wt % to about 12 wt % of benzyl alcohol; from about 1 wt % to about 5 wt % of poly(vinyl pyrrolidone); and from about 76 wt % to about 92 wt % of isopropyl alcohol.

### Selected Definitions

As used herein, “weight percent,” “wt %, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “w1%,” etc.

As used herein, “g” represents gram; “L” represents liter; “mg” represents “milligram (10⁻³ gram);” “mL” or “cc” represents milliliter (10⁻³ liter). One “μL” equals to one micron liter (10⁻⁶ liter). The units “mg/100 g,” “mg/100 mL,” or “mg/L” are units of concentration or content of a component in a composition. One “mg/L” equals to one ppm (part per million). “Da” refers to Dalton, which is the unit for molecular weight; One Da equals to one g/mol. The unit of temperature used herein is degree Celsius (° C.).

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention. Thus, the term “consisting essentially of” when used in a claim of this invention is not intended to be interpreted to be equivalent to “comprising.”

As used herein, the terms “increase,” “increasing,” “increased,” “enhance,” “enhanced,” “enhancing,” and “enhancement” (and grammatical variations thereof) describe an elevation of at least about 1%, 5%, 10%, 15%, 25%, 50%, 75%, 100%, 150%, 200%, 300%, 400%, 500% or more as compared to a control.

As used herein, the terms “reduce,” “reduced,” “reducing,” “reduction,” “diminish,” and “decrease” (and grammatical variations thereof), describe, for example, a decrease of at least about 1%, 5%, 10%, 15%, 20%, 25%, 35%, 50%, 75%, 80%, 85%, 90%, 95%, 97%, 98%, 99%, or 100% as compared to a control. In particular embodiments, the reduction can result in no or essentially no (i.e., an insignificant amount, e.g., less than about 10% or even 5% or even 1%) detectable activity or amount.

As used herein, the phrase “biologically active ingredient” refers to any active ingredient or synergist in addition to the bug or insect repellent used in the composition.

### BRIEF DESCRIPTION OF THE DRAWINGS

FIG. 1 shows the correlation between the CPT and the ingredients of selected samples according to the present example.

FIG. 2 shows the results of accelerated storage stability of selected samples.

### DETAILED DESCRIPTION

The present disclosure provides nootkatone-containing compositions and methods of formulating the compositions and using the same for repelling bugs or insects.

In one aspect, the present disclosure is related to a bug or insect repellent composition. The composition comprises nootkatone or an analogue or derivative thereof; and a carrier. In some embodiments, the bug or insect repellent composition is in a form of a ready-to-use (RTU) product. The RTU product can be used directly without further dilution, modification, processing, or manipulation of the composition.

Provided are compositions including nootkatone or a derivative or analog thereof, generally in an amount of from 0.1 wt % to 10 wt % or greater, such as at least 10 wt %, at least 20 wt %, at least 25 wt %, or at least 50 wt %, and methods that include application of a composition containing nootkatone or a derivative or analog thereof, generally in an amount of from 0.1 wt % to 10 wt % or greater, such as at least 10 wt %, at least 20 wt %, at least 25 wt %, or at least 50 wt %, for repelling bugs or insects and/or preventing bugs or insects from attaching to a target surface or subject. In some applications, the compositions are formulated to release an effective amount of the present composition containing nootkatone or a derivative or analog thereof for a period of time selected from among at least 15 minutes, at least 30 minutes, at least 1 hour, 2 hours, 3 hours, 4 hours, 5 hours, 6, hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, at least 1 day, 2 days, 3 days, 4 days, 5 days.

Compositions provided herein are bug or insect repellent compositions based on nootkatone and/or analogs of nootkatone. Also provided are methods for repelling bugs or insects and/or preventing bugs or insects from attaching to a target surface or subject using the compositions containing nootkatone and/or analogs of nootkatone.

Provided are pesticidal compositions and methods for treating, controlling, repelling, eradicating, inactivating, paralyzing, and/or killing bugs or insects. Non-limiting examples of bugs or insects include Siphonaptera insects, such as cat flea (Ctenocephalides felis), dog flea (Ctenocephalides canis), oriental rat flea (Xenopsylla cheopis), human flea (Pulex irritans), chigoe (Tungapenetrans) and European rat flea (Nosopsyllus fasciatus); Anoplura insects, such as Head louse (Pediculus humanus capitis), crab louse (Pthirus pubis), short-nosed cattle louse (Haematopinus eurysternus), sheep louse (Dalmalinia ovis), hog louse (Haematopinus suis), long-nosed cattle louse (Linognathus vituli), cattle biting louse (Bovicola bovis), poultry shaft louse (Menopon gallinae), poultry body louse (Menacanthus stramineus), little blue cattle louse (Solenopotes capillatus), Haematopinus spp., Linognathus spp., Pediculus spp., Phtirus spp. and Solenopotes spp.; Acarina insects, such as bush tick (Haemaphysalis longicomis), Haemaphysalis flava, Dermacentor taiwanicus, American dog tick (Dermacentor variabilis), Ixodes ovatus, Ixodes persulcatus, black legged tick (Ixodes scapularis), lone star tick (Amblyomma americanum), Boophilus microplus, Rhipicephalus sanguineus, Ixodes holocyclus, western black legged tick (Ixodes paciiicus), Dermacentor andersoni, Ambryomma maculatum, ear mite (Octodectes cynotis), Psoroptes spp., Chorioptes spp., Otodectes spp., Sarcoptes spp., Notoedres spp., Knemidocoptes spp., Sacroptes scabiei, Demodex spp., follicle mite (Demodex canis), northern fowl mite (Ornithonyssus sylviarum), poultry red mite (Dermanyssus gallinae), Trombicula spp., Leptotrombidium akamushi, Ornithodorus hermsi, Ornithodorus turicata, Ornithonyssus bacoti, Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Cytodites spp. and Laminosioptes spp.; Heteroptera insects, such as common bedbug (Cimex lectularius), tropical bedbug (Cimex hemipterus), Reduvius senilis, Triatoma spp. Rhodnius spp., Panstrongylus spp., and Arilus critatus; and Mallophage (Amblycera and Ischnocera) insects, such as Trimenopon spp., Menopon spp., Trinoton spp., Bovicola spp., Werneckiella spp., Lepikentron spp., Trichodectes spp. and Felicola spp.

Also provided are bug and insect repelling compositions containing nootkatone and/or a derivative or analog thereof and methods for repelling ticks or preventing ticks from attaching to a target surface of subject, or in a space surrounding the subject, or in an environment occupied by a subject, such as a human or an animal, particularly humans and other mammals. Also provided are bug and insect repelling compositions containing nootkatone and/or derivatives or analogs thereof and methods for repelling bugs or insects, such as ants, bedbugs, carpet beetles, centipedes, chiggers, drain flies, dust mites, earwigs, fleas, flies, gnats, hornets, lice, millipedes, mites, mosquitoes, roaches, scabies, silverfish, spiders, stinkbugs, termites, ticks, wasps, weevils and yellow jackets.

Provided herein are compositions that contain nootkatone or an analog of nootkatone and a carrier for repelling bugs and insects. Also provided are personal care or skin care or cosmetic compositions, household care compositions, outdoor care compositions, cleansing compositions, insect repellents, insecticide or pesticide compositions, fabric treatment sheets, liquid fabric treatment compositions, fabric refresher spray compositions, moist towelette products, packaged appliable products, sprayable products, and aerosol propellant pressurized products, each containing the provided compositions that include nootkatone and/or an analog of nootkatone for repelling bugs or insects. Also provided are methods for repelling bugs or insects from a location, methods for repelling ticks, methods of preventing insect/bug biting or skin injury, methods for killing or inactivating a bug or an insect, by applying or providing a composition that contains nootkatone and/or an analog of nootkatone for repelling bugs or insects.

The compositions provided herein generally do not involve complex chemistry and are safe for topical application. In some embodiments, the present compositions do not involve emulsifier, surfactant, or other natural or synthetic oils that are expensive and/or non-essential. Therefore, when comparing with prior art compositions that involve complex formulations and/or immiscible systems such as emulsion, the present compositions advantageously provide extended stability and duration and do not give rise to unpredictable effect or unfavorable side-effects on prolonged exposure.

### Nootkatone

Nootkatone (4,4a,5,6,7,8-hexahydro-6-isopropenyl-4,4a-dimethyl-2(3II)-naphtalenone) is a natural organic compound and an important flavor constituent of grapefruit. Nootkatone has been used commercially to flavor soft drinks and other beverages, as well as being used in perfumery. Nootkatone has been shown as a repellent or insecticide against deer ticks and lone star ticks. (Jordan, Robert A., et al., Efficacy of Plant-Derived and Synthetic Compounds on Clothing as Repellents Against Ixodes scapularis and Amblyomma americanum (Acari: Ixodidae). Journal of Medical Entomology. 2012, 49 (1): 101-106). Nootkatone is an environmentally friendly compound without unpleasant “synthetic” smell. Recently, nootkatone was approved by the U.S. Environmental Protection Agency (EPA) for this use on Aug. 10, 2020. Nootkatone is nontoxic to humans, is an approved food additive, and is commonly used in foods, cosmetics, and pharmaceuticals.

As used herein, the term “nootkatone” encompasses any derivatives or analogs thereof. Analogs and derivates of nootkatone are known in the art. These include, but are not limited to, nootkatone-11, 12-epoxide, nootkatone-1,10-epoxide, nootkatone-1,10-11, 12-diepoxide, tetrahydronootkatone, 1,10-dihydronootkatone, isonootkatone, and nootkatol (see U.S. Pat. Nos. 6,897,244 and 7,112,700 and WO 2002/050053). For example, conversion of an enone to the corresponding saturated ketone can be carried out with an alkali metal (e.g., Na or Li) in the presence of a proton source (such as liquid ammonia, ethanol, or both) to produce tetrahydronootkatone (e.g., see Adcock et al., J. Org. Chem. 47: 2951 (1982)). Nootkatone also be converted into isonootkatone, tetrahydronootkatone, 11,12-dihydronootkatone or 1,10-dihydronootkatone using well known methods (Stevens et al., J. Sci. Fd. Agric. 21: 590-593 (1970)). Zhu et al. describes the conversion of nootkatone into nootkatol (J. Chem. Ecol. 29: 2695-2701 (2003)).

Nootkatone may be naturally produced, or chemically synthesized, or produced by biosynthetic pathway. The conventional method for nootkatone preparation is by oxidation of valencene (see, e.g., U.S. Pat. Nos. 6,200,786 and 8,097,442). Nootkatone can also be synthesized, isolated, and purified from of a mixture of products produced in a host modified to express enzymes of the nootkatone biosynthetic pathway or that can be produced from naturally occurring sources, such as citrus plants. “Nootkatone” also refers to a mixture of chemical compounds containing or enriched for the nootkatone compound and derived from a modified host, such as a microorganism, or isolated or derived from plant extracts. The nootkatone compound contemplated for use herein may be produced in vivo through expression of one or more enzymes involved in the nootkatone biosynthetic pathway in a recombinant yeast or in vitro using isolated, purified enzymes involved in the nootkatone biosynthetic pathway, such as those described in U.S. Patent Application Publication NOs. 2015/0007368, 2012/0246767, and US 2015/0250166. Therefore, nootkatone as defined herein can differ structurally or chemically from other sources of nootkatone, such as extracts from plants and derivatives thereof, or may include such plant extracts and derivatives thereof.

It has been determined that the nootkatone is an effective repellent of bugs, insects, or pests, including but not limited to ants, bedbugs, carpet beetles, centipedes, chiggers, drain flies, dust mites, earwigs, fleas, flies, gnats, hornets, lice, millipedes, mites (such as dust mites and itch mites), mosquitoes, roaches, silverfish, spiders, stinkbugs, termites, ticks, wasps, weevils and yellow jackets, and is very effective in killing insect or bugs including ants, bedbugs, carpet beetles, centipedes, chiggers, drain flies, dust mites, itch mites, earwigs, fleas, flies, gnats, hornets, lice, millipedes, mites, mosquitoes, scabies, silverfish, spiders, stinkbugs, termites, ticks, wasps, weevils, and yellow jackets.

The amount of nootkatone or an analog or derivative thereof that is to be included in the composition can vary, but it has been determined that compositions that contain at 0.1 wt % to 10 wt %, or greater than 10 wt % nootkatone or an analog or derivative thereof are effective in controlling, including repelling and/or killing, insects or bugs, such as for up to several, including at least three days. The amount of nootkatone or a derivative or analog thereof can be increased in order to provide faster or longer control, such as knockdown, repelling, inactivating, or killing, of an insect or bug. For example, compositions containing nootkatone of or greater than about 0.1 wt %, or 0.5 wt %, or 1 wt %, or 2 wt %, or 5 wt %, or 7.5 wt %, or 10 wt %, or 15 wt %, or 20 wt %, or 25 wt % nootkatone and/or a derivative or analog thereof can be effective in repelling ticks. Higher concentrations of nootkatone or an analog or derivative thereof, such as at least at or about 15 wt % nootkatone or an analog or derivative thereof also can be included in order to prolong the residual action of the composition or increase the effect thereof.

The compositions provided herein include at least nootkatone or an analog or derivative thereof and a carrier. The nootkatone or analog or derivative thereof can be present in an amount of from at least at or about 0.1 wt % to at or about 10 wt %, or greater than 10 wt %, or greater that 15 wt %, or greater than 20 wt %, or greater than 25 wt % by weight of the composition. Generally, the composition contains from about or 0.1% to about or 10% nootkatone or an analog or derivative thereof. In some compositions, the composition contains greater than 10 wt %, or greater that 15 wt %, or greater than 20 wt %, or greater than 25 wt % nootkatone or an analog or derivative thereof. In some applications, the composition contains at least 1 wt % nootkatone or an analog or derivative thereof. In some applications, the composition contains greater than 10 wt % nootkatone or an analog or derivative thereof. In some applications, the composition contains greater than 0.1 wt %, 0.15 wt %, 0.2 wt %, 0.25 wt %, 0.3 wt %, 0.35 wt %, 0.4 wt %, 0.45%, 0.5%, 0.55%, 0.6%, 0.65%, 0.7%, 0.75%, 0.8%, 0.85%, 0.9%, 0.95%, 1%, 1.05%, 1.1%, 1.15%, 1.2 wt %, 1.25 wt %, 1.3 wt %, 1.35 wt %, 1.4 wt %, 1.45 wt %, 1.5 wt %, 1.55 wt %, 1.6 wt %, 1.65 wt %, 1.7 wt %, 1.75 wt %, 1.8 wt %, 1.85 wt %, 1.9 wt %, 1.95 wt %, 2 wt %, 2.05 wt %, 2.1 wt %, 2.15 wt %, 2.2 wt %, 2.25 wt %, 2.3 wt %, 2.35 wt %, 2.4 wt %, 2.45 wt %, 2.5 wt %, 2.55 wt %, 2.6 wt %, 2.65 wt %, 2.7 wt %, 2.75 wt %, 2.8 wt %, 2.85 wt %, 2.9 wt %, 2.95 wt %, 3 wt %, 3.05 wt %, 3.1 wt %, 3.15 wt %, 3.2 wt %, 3.25 wt %, 3.3 wt %, 3.35 wt %, 3.4 wt %, 3.45 wt %, 3.5 wt %, 3.55 wt %, 3.6 wt %, 3.65 wt %, 3.7 wt %, 3.75 wt %, 3.8 wt %, 3.85 wt %, 3.9 wt %, 3.95 wt %, 4 wt %, 4.05 wt %, 4.1 wt %, 4.15 wt %, 4.2 wt %, 4.25 wt %, 4.3 wt %, 4.35 wt %, 4.4 wt %, 4.45 wt %, 4.5 wt %, 4.55 wt %, 4.6 wt %, 4.65 wt %, 4.7 wt %, 4.75 wt %, 4.8 wt %, 4.85 wt %, 4.9 wt %, 4.95 wt %, 5 wt %, 5.05 wt %, 5.1 wt %, 5.15 wt %, 5.2 wt %, 5.25 wt %, 5.3 wt %, 5.35 wt %, 5.4 wt %, 5.45 wt %, 5.5 wt %, 5.55 wt %, 5.6 wt %, 5.65 wt %, 5.7 wt %, 5.75 wt %, 5.8 wt %, 5.85 wt %, 5.9 wt %, 5.95 wt %, 6 wt %, 6.05 wt %, 6.1 wt %, 6.15 wt %, 6.2 wt %, 6.25 wt %, 6.3 wt %, 6.35 wt %, 6.4 wt %, 6.45 wt %, 6.5 wt %, 6.55 wt %, 6.6 wt %, 6.65 wt %, 6.7 wt %, 6.75 wt %, 6.8 wt %, 6.85 wt %, 6.9 wt %, 6.95 wt %, 7 wt %, 7.05 wt %, 7.1 wt %, 7.15 wt %, 7.2 wt %, 7.25 wt %, 7.3 wt %, 7.35 wt %, 7.4 wt %, 7.45 wt %, 7.5 wt %, 7.55 wt %, 7.6 wt %, 7.65 wt %, 7.7 wt %, 7.75 wt %, 7.8 wt %, 7.85 wt %, 7.9 wt %, 7.95 wt %, 8 wt %, 8.05 wt %, 8.1 wt %, 8.15 wt %, 8.2 wt %, 8.25 wt %, 8.3 wt %, 8.35 wt %, 8.4 wt %, 8.45 wt %, 8.5 wt %, 8.55 wt %, 8.6 wt %, 8.65 wt %, 8.7 wt %, 8.75 wt %, 8.8 wt %, 8.85 wt %, 8.9 wt %, 8.95 wt %, 9 wt %, 9.05 wt %, 9.1 wt %, 9.15 wt %, 9.2 wt %, 9.25 wt %, 9.3 wt %, 9.35 wt %, 9.4 wt %, 9.45 wt %, 9.5 wt %, 9.55 wt %, 9.6 wt %, 9.65 wt %, 9.7 wt %, 9.75 wt %, 9.8 wt %, 9.85 wt %, 9.9 wt %, 9.95 wt %, 10 wt %, 10.05 wt %, 10.1 wt %, 10.15 wt %, 10.2 wt %, 10.25 wt %, 10.3 wt %, 10.35 wt %, 10.4 wt %, 10.45 wt %, 10.5 wt %, 10.55 wt %, 10.6 wt %, 10.65 wt %, 10.7 wt %, 10.75 wt %, 10.8 wt %, 10.85 wt %, 10.9 wt %, 10.95 wt %, 11 wt %, 11.05 wt %, 11.1 wt %, 11.15 wt %, 11.2 wt %, 11.25 wt %, 11.3 wt %, 11.35 wt %, 11.4 wt %, 11.45 wt %, 11.5 wt %, 11.55 wt %, 11.6 wt %, 11.65 wt %, 11.7 wt %, 11.75 wt %, 11.8 wt %, 11.85 wt %, 11.9 wt %, 11.95 wt %, 12 wt %, 12.05 wt %, 12.1 wt %, 12.15 wt %, 12.2 wt %, 12.25 wt %, 12.3 wt %, 12.35 wt %, 12.4 wt %, 12.45 wt %, 12.5 wt %, 12.55 wt %, 12.6 wt %, 12.65 wt %, 12.7 wt %, 12.75 wt %, 12.8 wt %, 12.85 wt %, 12.9 wt %, 12.95 wt %, 13 wt %, 13.05 wt %, 13.1 wt %, 13.15 wt %, 13.2 wt %, 13.25 wt %, 13.3 wt %, 13.35 wt %, 13.4 wt %, 13.45 wt %, 13.5 wt %, 13.55 wt %, 13.6 wt %, 13.65 wt %, 13.7 wt %, 13.75 wt %, 13.8 wt %, 13.85 wt %, 13.9 wt %, 13.95 wt %, 14 wt %, 14.05 wt %, 14.1 wt %, 14.15 wt %, 14.2 wt %, 14.25 wt %, 14.3 wt %, 14.35 wt %, 14.4 wt %, 14.45 wt %, 14.5 wt %, 14.55 wt %, 14.6 wt %, 14.65 wt %, 14.7 wt %, 14.75 wt %, 14.8 wt %, 14.85 wt %, 14.9 wt %, 14.95 wt %, 15 wt %, 15.05 wt %, 15.1 wt %, 15.15 wt %, 15.2 wt %, 15.25 wt %, 15.3 wt %, 15.35 wt %, 15.4 wt %, 15.45 wt %, 15.5 wt %, 15.55 wt %, 15.6 wt %, 15.65 wt %, 15.7 wt %, 15.75 wt %, 15.8 wt %, 15.85 wt %, 15.9 wt %, 15.95 wt %, 16 wt %, 16.05 wt %, 16.1 wt %, 16.15 wt %, 16.2 wt %, 16.25 wt %, 16.3 wt %, 16.35 wt %, 16.4 wt %, 16.45 wt %, 16.5 wt %, 16.55 wt %, 16.6 wt %, 16.65 wt %, 16.7 wt %, 16.75 wt %, 16.8 wt %, 16.85 wt %, 16.9 wt %, 16.95 wt %, 17 wt %, 17.05 wt %, 17.1 wt %, 17.15 wt %, 17.2 wt %, 17.25 wt %, 17.3 wt %, 17.35 wt %, 17.4 wt %, 17.45 wt %, 17.5 wt %, 17.55 wt %, 17.6 wt %, 17.65 wt %, 17.7 wt %, 17.75 wt %, 17.8 wt %, 17.85 wt %, 17.9 wt %, 17.95 wt %, 18 wt %, 18.05 wt %, 18.1 wt %, 18.15 wt %, 18.2 wt %, 18.25 wt %, 18.3 wt %, 18.35 wt %, 18.4 wt %, 18.45 wt %, 18.5 wt %, 18.55 wt %, 18.6 wt %, 18.65 wt %, 18.7 wt %, 18.75 wt %, 18.8 wt %, 18.85 wt %, 18.9 wt %, 18.95 wt %, 19 wt %, 19.05 wt %, 19.1 wt %, 19.15 wt %, 19.2 wt %, 19.25 wt %, 19.3 wt %, 19.35 wt %, 19.4 wt %, 19.45 wt %, 19.5 wt %, 19.55 wt %, 19.6 wt %, 19.65 wt %, 19.7 wt %, 19.75 wt %, 19.8 wt %, 19.85 wt %, 19.9 wt %, 19.95 wt %, or 20 wt % nootkatone or an analog or derivative thereof by weight of the composition.

It certain embodiments, the nootkatone of the present composition has a content from about 0.1 wt % to about 20 wt %, or from about 1 wt % to about 18 wt %, or from about 2 wt % to about 16 wt %, or from about 3 wt % to about 14 wt %, or from about 4 wt % to about 12 wt %, or from about 5 wt % to about 10 wt %, or from about 6 wt % to about 8 wt %, based on the total weight of the composition. In one particular embodiments, the nootkatone content of the present composition is from about 3 wt % to about 7 wt %, based on the total weight of the composition. It is noted that a balanced content of nootkatone can be both functionally effective in repelling insects and bugs and cost-effective to make the products containing the composition affordable when in need of a large quantity.

Other than increasing the amount of the nootkatone in the present composition, residual action of the composition also can be modulated by selection of the carrier and other components of the composition. For example, when the carrier includes or is a solvent, a solvent having a particular vapor pressure, or a combination of solvents having differing vapor pressures, can be used to modify the evaporative rate or vaporization rate of the nootkatone or analog derivative thereof from the composition. Other components also can be included in the composition in order to modulate the residual action of the nootkatone or analog or derivative thereof. For example, a surfactant with which the nootkatone can interact can be included in the composition, which can reduce the rate of evaporation and thereby increase the residual action of the composition. Polymers and thickeners and other viscosity modulating agents also can be included in the composition to modulate the viscosity of the composition, and thereby slow the release of the nootkatone or analog or derivative thereof from the composition or otherwise prolong the time that the insect/bug is exposed to the composition or vapors from the composition. Synergists or functional enhancers also can be included in the composition. Examples of suitable synergists or functional enhancers for use in the compositions include p-menthane-3,8-diol (PMD), vanillin, Eugenol, Citral, linalool, terpene-oil or terpene derivatives, cuminaldehyde, thyme oil, clove oil, oil of Lemon Eucalyptus (OLE), bis-(2,3,3,3-tetrachloropropyl)ether, dodecyl imidazole, N-(2-ethylhexyl)bicyclo-[2,2,1]hept-5-ene-2,3-dicarboxyimide piperonyl butoxide, isobornyl thiocyanatoacetate, safroxan, and sesamex, and combinations thereof in any proportion.

### Carrier

The compositions provided herein containing nootkatone or an analog or derivative thereof include a carrier. The carrier generally is mixed with the nootkatone or derivative or analog thereof and generally is selected to facilitate the application of the composition to a targeted subject, such as a surface or space or location, or to facilitate storage, transport and/or handling of the composition. The carrier can be in the form of solid and/or liquid and/or gas, such as a propellant.

The provided compositions contain a liquid carrier selected from among, but not limited to, water, an alcohol, an aldehyde, an alkane, an alkene, an amide, an amine, a diglyceride, an ester, an ether, a glycol ether, a fat, a fatty acid, a glycol ester, a ketone, lanolin, mineral oil, a monoglyceride, paraffin oil, a polyethylene glycol, petrolatum, a propylene carbonate, a N-methyl pyrrolidone, a g-butyrolactone, a dipropylene glycol monomethyl ether, silicone, tall oils, a terpene hydrocarbon, a terpene alcohol, a triglyceride, finely divided organic solid material, finely divided inorganic solid materials and mixtures thereof. In one embodiment, the carrier can be an alcohol that is selected from among an aromatic alcohol, a C1-C6 monohydric alcohol, C2-C6 polyhydric alcohol, a polyvalent alcohol, and mixtures thereof. In one example, the carrier is an alcohol that is selected from among methanol, ethanol, 1-propanol, 2-propanol (isopropyl alcohol), 1-butanol, 2-butanol, tert-butanol, 2-methyl-1-propanol, 1-pentanol, 2-pentanol, 3-methyl-1-butanol, 3-methyl-2-butanol, ethylene glycol, propylene glycol, 1,4-butanediol, 1,3-butanediol, 1,3-butanediol, 2-methyl-1,3-propanediol, 1,4-cyclohexanedimethanol, diethylene glycol, triethylene glycol, PEG-200, PEG-300, PEG-400, PEG-600, 2-methoxyethanol, 2-ethoxyethanol, 2-propoxyethanol, 2-isopropoxyethanol, 2-butoxyethanol, 1-methoxy-2-propanol, 1-ethoxy-2-propanol, 3-methoxy-1-butanol, diethylene glycol monomethyl ether, diethylene glycol monoethyl ether, diethylene glycol mono-n-propyl ether, diethylene glycol mono-isopropyl ether, diethylene glycol monobutyl ether, triethylene glycol monomethyl ether, glycerol, octyl alcohol, decyl alcohol, tetrahydrofurfuryl alcohol, 3-methoxy-1, 2-propanediol, or 3-ethoxy-1,2-propanediol, and combinations thereof in any proportion. In one example, the carrier in the provided compositions is ethanol. In a preferred example, the compositions contain a carrier that is isopropanol.

In another example, the carrier in the provided compositions contains borneol, citronellol or geraniol or a combination thereof. In some applications, the carrier in the compositions provided herein contains or is a cyclodextrin that is selected from among an a-cyclodextrin, (3-cyclodextrin or y-cyclodextrin or a combinations thereof.

It has been found that isopropanol is particularly advantageous in improving the dissolution of nootkatone in the composition. Isopropanol is a low cost alcohol solvent with a boiling point of about 82.5° C., mild volatility, and minimum toxicity. Isopropanol is superb in solubilizing nootkatone, and/or homogenizing/stabilizing various components of the present composition, thereby prolonging the duration and effectiveness when the composition in use.

In one embodiment, the carrier consists essentially of isopropyl alcohol. In a particular embodiments, the composition has only isopropyl alcohol and is free or substantially free from other alcohol used as a carrier or solvent.

In some embodiments, the liquid carrier contains up to at or about 99 wt %, by weight, of the composition. For example, the composition can contain at least 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt % or 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, or 99 wt % liquid carrier, by, weight, of the composition.

Liquid carriers also can provide water repellency and thereby extend the effectiveness of the composition on a targeted subject, such as human skin. Some liquid carriers, particular some vegetable oils, can help to prevent skin irritation, and/or soothe and condition skin. Factors to consider when selecting a carrier(s) for the compositions provided herein include commercial availability, cost, repellency, evaporation rate, odor, and stability. Some carriers can themselves have repellent properties.

In some embodiments, the carrier in the composition or formulation provided herein is or includes a gas. Generally, the gas is provided in the form of a propellant that can be a liquid when contained in a container under pressure, and converts to a gas upon removal of the pressure. For example, halogenated or unhalogenated gaseous aliphatic hydrocarbons and mixtures thereof can be liquefied at 20° C. by use of an excess pressure of at least 0.5 atmosphere. Exemplary gas carriers for use in the compositions and formulations include, but are not limited to, aerosol propellants, such as argon, butane, carbon dioxide, a chlorofluorocarbon, such as dichlorodifluoromethane or dichlorotetrafluoroethane, dimethyl ether, a hydrocarbon, a hydrofluorocarbon, such as difluoromethane, trifluoromethane, difluoroethane, trifluoroethane, tetrafluoroethane, or octafluorocyclobutane, isobutane, nitrogen, propane, or mixtures thereof, butane, dimethyl ether, a fluorocarbon, and carbon dioxide. The amount of gas carrier included in the compositions or formulations can vary, and can be selected based on any one of several criteria, including the physical behavior of the propellant, on the type of nozzle or device selected to deploy the composition, and on the volume of the pressure vessel used. The proportion of gas carrier in the composition or formulation can vary from between at or about 10% to at or about 90%, by weight, of the composition.

In some embodiments, the carrier in the compositions provided herein is an aerosol propellant that is selected from among argon, butane, carbon dioxide, a chlorofluorocarbon, dimethyl ether, a hydrocarbon, a hydrofluorocarbon, isobutane, nitrogen, propane, and a mixture thereof. In a particular example, the aerosol propellant contains difluoromethane, trifluoromethane, difluoroethane, trifluoroethane, tetrafluoroethane or octafluorocyclobutane or a combination thereof.

### Dispersing Agent

In some embodiments, the composition further comprises a dispersing agent. The dispersing agent may provide multiple benefits or useful functions. For example, the dispersing agent may play a role of viscosity modification/adjustment. When the composition is applied to a subject, the dispersing agent may facilitate uniform application and formation of an even layer or film of nootkatone on targeted surface of the subject. The dispersing agent may also enhance the stability and duration of nootkatone that is applied onto the targeted surface, preventing it from evaporation or deterioration too fast. The dispersing agent may be a consumer-friendly or skin-caring material that is healthy, neutral, and not too greasy or oily.

In some embodiments, the dispersing agent of the present composition is selected from among, but not limited to, poly(vinyl pyrrolidone), polyacry late, poly(acrylic acid), poly(ethylene glycol), poly(vinyl alcohol), poly(vinyl acetate), polyacrylate carboxy late copolymer, styrene acrylic acid copolymer, alkyl-polyglucoside, and combinations thereof in any proportion, polyoxyethylated castor oil, a polyoxyethylene sorbitan ester, alkylnaphthalene sulfonate, alkylbenzenesulfonate, polyoxyethylene, lignin sulfonate, sodium silicate, potassium silicate, methylcellulose, carboxymethyl cellulose, hydroxypropylcellulose, hydroxypropyl-methylcellulose, gum arabic, a polyacrylate, and an acrylic/maleic copolymers and combinations thereof. In one particular embodiment, the dispersing agent is polymer consisting essentially of poly(vinyl pyrrolidone). In another particular embodiment, the present composition comprises poly(vinyl pyrrolidone) and is free or substantially free from other polymer or polymeric material.

Poly(vinyl pyrrolidone), also known as povidone, is known to be used in the pharmaceutical industry as a synthetic polymer vehicle for dispersing and suspending drugs. It has been found that the excellent film-forming property of poly(vinyl pyrrolidone) significantly improved the efficiency of topical administration. Poly(vinyl pyrrolidone) has also been shown to be effective for controlling release of nootkatone and/or other function ingredients in application of the present composition.

The dispersing agent can be present in the provided compositions in an amount of about 0.002% to about 25% by weight of the composition. In embodiments, dispersing agent has a content of about 0.1 wt % to about 10 wt %, or from about 0.5 wt % to about 8 wt %, or from about 1 wt % to about 6 wt %, or from about 1.5 wt % to about 5 wt %, or from about 2 wt % to about 4 wt %. In some examples, the dispersing agent is present in an amount of about 0.025 wt % to about 25 wt % by weight of the composition. In other examples, the dispersing agent is present in an amount of about 0.01 wt % to about 15 wt % by weight of the composition. In yet other examples, the dispersing agent is present in an amount of about 0.05 wt % to about 10 wt % by weight of the composition, for example, in an amount at or about at least 0.05 wt %, 0.1 wt %, 0.15 wt %, 0.2 wt %, 0.25 wt %, 0.3 wt %, 0.35 wt %, 0.3 wt %, 0.35 wt %, 0.5 wt %, 0.55 wt %, 0.6 wt %, 0.65 wt %, 0.7 wt %, 0.75 wt %, 0.8 wt %, 0.85 wt %, 0.9 wt %, 0.95 wt %, 1 wt %, 1.05 wt %, 1.1 wt %, 1.15 wt %, 1.2 wt %, 1.25 wt %, 1.3 wt %, 1.35 wt %, 1.4 wt %, 1.45 wt %, 1.5 wt %, 1.55 wt %, 1.6 wt %, 1.65 wt %, 1.7 wt %, 1.75 wt %, 1.8 wt %, 1.85 wt %, 1.9 wt %, 1.95 wt %, 2 wt %, 2.05 wt %, 2.1 wt %, 2.15 wt %, 2.2 wt %, 2.25 wt %, 2.3 wt %, 2.35 wt %, 2.4 wt %, 2.45 wt %, 2.5 wt %, 2.55 wt %, 2.6 wt %, 2.65 wt %, 2.7 wt %, 2.75 wt %, 2.8 wt %, 2.85 wt %, 2.9 wt %, 2.95 wt %, 3 wt %, 3.05 wt %, 3.1 wt %, 3.15 wt %, 3.2 wt %, 3.25 wt %, 3.3 wt %, 3.35 wt %, 3.4 wt %, 3.45 wt %, 3.5 wt %, 3.55 wt %, 3.6 wt %, 3.65 wt %, 3.7 wt %, 3.75 wt %, 3.8 wt %, 3.85 wt %, 3.9 wt %, 3.95 wt %, 4 wt %, 4.05 wt %, 4.1 wt %, 4.15 wt %, 4.2 wt %, 4.25 wt %, 4.3 wt %, 4.35 wt %, 4.4 wt %, 4.45 wt %, 4.5 wt %, 4.55 wt %, 4.6 wt %, 4.65 wt %, 4.7 wt %, 4.75 wt %, 4.8 wt %, 4.85 wt %, 4.9 wt %, 4.95 wt %, 5 wt %, 5.05 wt %, 5.1 wt %, 5.15 wt %, 5.2 wt %, 5.25 wt %, 5.3 wt %, 5.35 wt %, 5.4 wt %, 5.45 wt %, 5.5 wt %, 5.55 wt %, 5.6 wt %, 5.65 wt %, 5.7 wt %, 5.75 wt %, 5.8 wt %, 5.85 wt %, 5.9 wt %, 5.95 wt %, 6 wt %, 6.05 wt %, 6.1 wt %, 6.15 wt %, 6.2 wt %, 6.25 wt %, 6.3 wt %, 6.35 wt %, 6.4 wt %, 6.45 wt %, 6.5 wt %, 6.55 wt %, 6.6 wt %, 6.65 wt %, 6.7 wt %, 6.75 wt %, 6.8 wt %, 6.85 wt %, 6.9 wt %, 6.95 wt %, 7 wt %, 7.05 wt %, 7.1 wt %, 7.15 wt %, 7.2 wt %, 7.25 wt %, 7.3 wt %, 7.35 wt %, 7.4 wt %, 7.45 wt %, 7.5 wt %, 7.55 wt %, 7.6 wt %, 7.65 wt %, 7.7 wt %, 7.75 wt %, 7.8 wt %, 7.85 wt %, 7.9 wt %, 7.95 wt %, 8 wt %, 8.05 wt %, 8.1 wt %, 8.15 wt %, 8.2 wt %, 8.25 wt %, 8.3 wt %, 8.35 wt %, 8.4 wt %, 8.45 wt %, 8.5 wt %, 8.55 wt %, 8.6 wt %, 8.65 wt %, 8.7 wt %, 8.75 wt %, 8.8 wt %, 8.85 wt %, 8.9 wt %, 8.95 wt %, 9 wt %, 9.05 wt %, 9.1 wt %, 9.15 wt %, 9.2 wt %, 9.25 wt %, 9.3 wt %, 9.35 wt %, 9.4 wt %, 9.45 wt %, 9.5 wt %, 9.55 wt %, 9.6 wt %, 9.65 wt %, 9.7 wt %, 9.75 wt %, 9.8 wt %, 9.85 wt %, 9.9 wt %, 9.95 wt %, and 10 wt % by weight of the composition. In one example, the ratio of nootkatone or analog of nootkatone to dispersing agent in the provided compositions is at or about 10:1 (w/w) to at or about 1:10 (w/w).

### Solvent

In some embodiments, the composition further comprises a solvent (dissolution agent). The solvent may be a potent solvent. The solvent may enhance the solubility of nootkatone in the composition, prolong the stability and durability of the composition, improve the effectiveness of nootkatone when use, and/or prevent unfavorable settlement or precipitation. Non-limiting examples of the solvent include polyol, an aromatic alcohol, propylene glycol, hexylene glycol, butanediol, diethylene glycol, benzyl alcohol, terpenoid or derivatives thereof, terpene-ol, terpene-diol, phthalate ester, dioxolane, dimethylformanide, dimethyl solfoxide (DMSO), methyl dodecyl sulfoxide, ethyl oleate, ethyl caprylate, diisopropyl adipate, dimethylacetamide, N-methylpyrrolidone, N-hydroxyethylpyrrolidone, dimethylacetamide, azone (1-dodecylazacycloheptan-2-one), 2-(n-nonyl)-1,3-dioxolane, an isosorbide derivative, dimethyl isosorbide, glycofurol, ethoxydiglycol (transcutol), and combinations thereof in any proportion.

In some embodiments, the solvent may be a potent, aromatic solvent including but not limited to benzyl alcohol, phthalate ester, dimethyl phthalate, diethyl phthalate, dipropyl phthalate, butyl phthalate, and combinations thereof in any proportion, and combinations thereof in any proportion.

In a particular embodiment, the solvent consists essentially of benzyl alcohol. For example, benzyl alcohol is a clear, colorless liquid with a mild aromatic odor. It has a molecular mass of 108.14 g/mol and molecular formula C₆H₅CH₂OH. It has a low vapor pressure, is a polar and hydrophilic solvent and is completely miscible in alcohols. It is found naturally in the essential oils of some plants and has low toxicity (an LD₅₀ of 1.2 g/kg in rats) and is oxidized rapidly in healthy individuals to benzoic acid, conjugated with glycine in the liver, and excreted as hippuric acid. Commercially, benzyl alcohol can be used as a precursor for esters used in the flavors and fragrance industry, including perfumes and soaps. Used as a single active ingredient, it has some bacteriostatic properties. Benzyl alcohol used in the present composition can be a synergist or functional enhancer when used as a co-solvent along with the carrier such as isopropyl alcohol (IPA), and benzyl alcohol has been found extremely effective in promoting the solubility of nootkatone and the stability of the composition.

Benzyl alcohol is also an ingredient used in the manufacture of topical creams, skin lotions, facial cleansers, head lice formulation & shampoos, and is popular due to its anti-bacterial and anti-fungal and preservative properties.

In some embodiments, the solvent of the present composition has a content from about 0.1 wt % to about 20 wt %, or from about 1 wt % to about 12 wt %, or from about 2 wt % to about 8 wt %, or from about 3 wt % to about 7 wt %, or from about 4 wt % to about 6 wt %, based on the total weight of the composition.

### Surfactant/Emulsifier

In some embodiments, the present composition includes a surfactant. A surfactant is a surface-active agent, which refers to any compound that reduces surface tension when dissolved in water or water solutions, or that reduces interfacial tension between two liquids, or between a liquid and a solid. Examples of surfactants include, but are not limited to: (1) fatty acid esters such as glycerol esters, PEG esters, and sorbitan esters, including ethylene glycol distearate, ethylene glycol monostrearate, glycerol mono and/or dioleate, PEG dioleate, PEG monolaurate, sorbitan monolaurate, sorbitan trioleate; (2) nonionic ethoxylates such as alkylphenol ethoxylates, alcohol ethoxylates, alkylamine ethoxylates, such as octylphenol ethoxylate, nonylphenol ethoxylate, alkylamine ethoxylates; (3) nonionic surfactants such as 2,4, 7,9-tetramethyl-5-decyn-4,7-diol; and (4) ethylene oxide/propylene oxide copolymers. In some embodiments, the surfactant can serve as a synergist or functional enhancer described herein. For example, the surfactant with which the nootkatone can interact can be included in the composition, which can reduce the rate of evaporation and thereby increase the residual action of the composition.

In some embodiments, the surfactant is selected from among an anionic surfactant, a cationic, a nonionic surfactant, and a zwitterionic surfactant and a combination thereof. In a particular example, the surfactant is an anionic surfactant that is selected from among fatty soaps, alkyl sulfates, sulfated oils, ether sulfates, sulfonates, sulfosuccinates, sulfonated amides and isethionates. In another example, the anionic surfactant is selected from among alkyl sulfonate surfactants, a linear alkylbenzene sulfonic acid, a branched alkylbenzene sulfonic acid a C12-C18 alkylsulfate, C12-C18 alkyl alkoxy sulfate, C12-C18 alkyl methyl ester sulfonate and combinations thereof. In a particular example, the surfactant is a cationic surfactant that is selected from among an alkylamine, an alkyl diamine, an alkyl polyamine, a mono or di-quaternary ammonium salt, a monoalkoxylated amine, a dialkoxylated amine, a monoalkoxylated quaternary ammonium salt, a dialkoxylated quaternary ammonium salt, an etheramine, an amine oxide, an alkoxylated amine oxide and a fatty imidazoline and combinations thereof. In another particular example, the surfactant is a non-ionic surfactant that is selected from among an alkoxylated alcohol, a dialkoxylated alcohol, an alkoxylated dialkylphenol, an alkylpolyglycoside, an alkoxylated alkylphenol, an alkoxylated glycol, an alkoxylated mercaptan, an alkylamine salt, an alkyl quaternary amine salt, a glyceryl or polyglyceryl ester of a natural fatty acid, an alkoxylated glycol ester, an alkoxylated fatty acid, an alkoxylated alkanolamide, a polyalkoxylated silicone and an N-alkyl pyrrolidone and combinations thereof.

The surfactant can be present in the provided compositions in an amount of about 0.002 wt % to at or about 20 wt % by weight of the composition. In some examples, the surfactant is present in an amount of about 0.025 wt % to about 20 wt % by weight of the composition. In other examples, the surfactant is present in an amount of about 0.01 wt % to about 15 wt % by weight of the composition. In yet other examples, the surfactant is present in an amount of about 0.05 wt % to about 10 wt % by weight of the composition, for example, in an amount at or about at least 0.05 wt %, 0.06 wt %, 0.07 wt %, 008 wt %, 0.09 wt %, 0.1 wt %, 0.15 wt %, 0.2 wt %, 0.25 wt %, 0.3 wt %, 0.35 wt %, 0.3 wt %, 0.35 wt %, 0.5 wt %, 0.55 wt %, 0.6 wt %, 0.65 wt %, 0.7 wt %, 0.75 wt %, 0.8 wt %, 0.85 wt %, 0.9 wt %, 0.95 wt %, 1 wt %, 1.05 wt %, 1.1 wt %, 1.15 wt %, 1.2 wt %, 1.25 wt %, 1.3 wt %, 1.35 wt %, 1.4 wt %, 1.45 wt %, 1.5 wt %, 1.55 wt %, 1.6 wt %, 1.65 wt %, 1.7 wt %, 1.75 wt %, 1.8 wt %, 1.85 wt %, 1.9 wt %, 1.95 wt %, 2 wt %, 2.05 wt %, 2.1 wt %, 2.15 wt %, 2.2 wt %, 2.25 wt %, 2.3 wt %, 2.35 wt %, 2.4 wt %, 2.45 wt %, 2.5 wt %, 2.55 wt %, 2.6 wt %, 2.65 wt %, 2.7 wt %, 2.75 wt %, 2.8 wt %, 2.85 wt %, 2.9 wt %, 2.95 wt %, 3 wt %, 3.05 wt %, 3.1 wt %, 3.15 wt %, 3.2 wt %, 3.25 wt %, 3.3 wt %, 3.35 wt %, 3.4 wt %, 3.45 wt %, 3.5 wt %, 3.55 wt %, 3.6 wt %, 3.65 wt %, 3.7 wt %, 3.75 wt %, 3.8 wt %, 3.85 wt %, 3.9 wt %, 3.95 wt %, 4 wt %, 4.05 wt %, 4.1 wt %, 4.15 wt %, 4.2 wt %, 4.25 wt %, 4.3 wt %, 4.35 wt %, 4.4 wt %, 4.45 wt %, 4.5 wt %, 4.55 wt %, 4.6 wt %, 4.65 wt %, 4.7 wt %, 4.75 wt %, 4.8 wt %, 4.85 wt %, 4.9 wt %, 4.95 wt %, 5 wt %, 5.05 wt %, 5.1 wt %, 5.15 wt %, 5.2 wt %, 5.25 wt %, 5.3 wt %, 5.35 wt %, 5.4 wt %, 5.45 wt %, 5.5 wt %, 5.55 wt %, 5.6 wt %, 5.65 wt %, 5.7 wt %, 5.75 wt %, 5.8 wt %, 5.85 wt %, 5.9 wt %, 5.95 wt %, 6 wt %, 6.05 wt %, 6.1 wt %, 6.15 wt %, 6.2 wt %, 6.25 wt %, 6.3 wt %, 6.35 wt %, 6.4 wt %, 6.45 wt %, 6.5 wt %, 6.55 wt %, 6.6 wt %, 6.65 wt %, 6.7 wt %, 6.75 wt %, 6.8 wt %, 6.85 wt %, 6.9 wt %, 6.95 wt %, 7 wt %, 7.05 wt %, 7.1 wt %, 7.15 wt %, 7.2 wt %, 7.25 wt %, 7.3 wt %, 7.35 wt %, 7.4 wt %, 7.45 wt %, 7.5 wt %, 7.55 wt %, 7.6 wt %, 7.65 wt %, 7.7 wt %, 7.75 wt %, 7.8 wt %, 7.85 wt %, 7.9 wt %, 7.95 wt %, 8 wt %, 8.05 wt %, 8.1 wt %, 8.15 wt %, 8.2 wt %, 8.25 wt %, 8.3 wt %, 8.35 wt %, 8.4 wt %, 8.45 wt %, 8.5 wt %, 8.55 wt %, 8.6 wt %, 8.65 wt %, 8.7 wt %, 8.75 wt %, 8.8 wt %, 8.85 wt %, 8.9 wt %, 8.95 wt %, 9 wt %, 9.05 wt %, 9.1 wt %, 9.15 wt %, 9.2 wt %, 9.25 wt %, 9.3 wt %, 9.35 wt %, 9.4 wt %, 9.45 wt %, 9.5 wt %, 9.55 wt %, 9.6 wt %, 9.65 wt %, 9.7 wt %, 9.75 wt %, 9.8 wt %, 9.85 wt %, 9.9 wt %, 9.95 wt % and 10 wt % by weight of the composition. In one example, the ratio of nootkatone or analog of nootkatone to surfactant in the provided compositions is at or about 5:1 (w/w) to at or about 1:10 (w/w).

In some embodiments, the present composition is free or substantially free from the surfactant described herein. In one particular example, the present composition consists essentially of organic compounds and is free of substantially free from water. As such, the composition is non-aqueous or substantially non-aqueous, and no surfactant or surface-active agent is present in the composition.

In some embodiments, the present composition is not an emulsion and is free or substantially free from an emulsifier. Emulsifiers that can be included in the compositions and formulations include, for example, ionic, non-ionic, zwitterionic and/or anionic surfactants as described above. In some examples, the emulsifier is a surfactant that is anionic, such as sodium lauryl sulfate (USP) and its derivatives, alkyl sulfonate surfactants, a linear alkylbenzene sulfonic acid, a branched alkylbenzene sulfonic acid a C12-C18 alkylsulfate, C12-C18 alkyl alkoxy sulfate, C12-C18 alkyl methyl ester sulfonate, fatty soaps, alkyl sulfates, sulfated oils, ether sulfates, sulfonates, sulfosuccinates, sulfonated amides and isethionates; a zwitterionic surfactant; cationic surfactant, such as an alkylamine, an alkyl diamine, an alkyl polyamine, a mono- or di-quaternary ammonium salt, a monoalkoxylated amine, a dialkoxylated amine, a monoalkoxylated quaternary ammonium salt, a dialkoxylated quaternary ammonium salt, an etheramine, an amine oxide, an alkoxylated amine oxide and a fatty imidazoline, quaternary ammonium halides (such as cetyl pyridinium chloride); or a non-ionic surfactant, such as linear fatty alcohol ethoxylates or their polyoxyethylene condensation products (such as Spans and Tweens), alkyl arylpolyglycol ethers, polyethylene oxide esters of fatty acids, polyglycerol esters of fatty acids, polyoxethylene sorbitan monolaurate, polyoxethylene sorbitan mono- or tri-stearate, polyoxyethylene sorbitan monoleate, propylene glycol mono and diesters of fats and fatty acids, aryl sulfonates, sorbitan monostearate, poloxamer and its derivatives, medium chain triglyceride, caprylocaproyl macrogolglycerides, diethyleneglycol monoethyl ether, PEG-6 olive oil, PEG-6 peanut oil, PEG-6 hydrogenated palm kernel oil, propylene glycol dicaprylate/dicaprate, polysorbate, sorbitan esters, polyethoxylated castor oil, PEG-60 hydrogenated castor oil, PEG40 hydrogenated castor oil, sodium lauryl glutamate, disodium cocoamphodiacetate, Polyoxyl 23 lauryl ester, an alkoxylated alcohol, a dialkoxylated alcohol, an alkoxylated dialkylphenol, an alkylpolyglycoside, an alkoxylated alkylphenol, an alkoxylated glycol, an alkoxylated mercaptan, an alkylamine salt, an alkyl quaternary amine salt, a glyceryl or polyglyceryl ester of a natural fatty acid, an alkoxylated glycol ester, an alkoxylated fatty acid, an alkoxylated alkanolamide, a polyalkoxylated silicone and an N-alkyl pyrrolidone.

### Viscosity Modulating Agent

In some embodiments, the composition includes a viscosity modulating agent. Viscosity modulating agents, such as polymers and thickeners, can be included in the formulation for any number of reasons. A viscosity modulating agent can help to stabilize a composition during shipping and storage by preventing separation of the component, or be slowing or preventing coalescence of dispersed particle or oil droplets. A viscosity modulating agent also can modify the rheology of the composition, thereby facilitating application to a targeted subject. For example, a viscosity modulating can be selected such that the composition when dispensed from a spraying device produces even or uniform droplets with little overspray. In applications where the composition is to be applied to a locus by brushing or dipping, a viscosity modulating agent can be selected so that the composition adheres to the surface of the subject. The viscosity modulating agent also can modifying the release profile of the composition and thereby slow the release of the nootkatone or analog or derivative thereof from the composition. It is noted that the dispersing agent, surfactant, carrier, solvent, essential oil and/or synergist or functional enhancer described herein may also function as a viscosity modulating agent.

Any viscosity modulating agent known in the art can be selected, based on the properties desired in the final composition. Some polymers have an intrinsic viscosity that they impart to a formulation based on the concentration of the viscosity modulating agent included in the composition. Lower molecular weight polymers generally tend to have lower viscosity contributing ability at lower concentrations, meaning that a higher percentage of viscosity modulating agent is required to achieve a higher viscosity in the final composition. The skilled artisan can select the type of viscosity modulating agent, its molecular weight and the percentage to include in the composition based on the chemistry and rheology of the viscosity modulating agent. For example, at or about 20 wt % or more gum arabic or similar compound can be used to provide film forming and viscosity modifying effects, while as little as 0.2 wt % xanthan gum can provide similar viscosities and stabilizing effects.

Non-limiting examples of viscosity modulating agents that can be included in the compositions provided herein include, but are not limited to, an acrylate, an acrylate copolymer, an alginate, an arabino-galactan, a carrageenan, a cellulosic polymer, such as any one of bacterial cellulose, carboxymethyl cellulose, ethyl cellulose, ethyl-hydroxyethylcellulose, hydroxylethyl cellulose, hydroxypropyl cellulose, hydroxy propyl methylcellulose, methyl cellulose, microparticulate cellulose and sodium carboxymethyl cellulose and combinations thereof, a ceramide, chitan, dextran, diutan, fucelleran, fucoidan, a (3-glucan, a gellan gum (native or low acetate), guar gum, gum arabic, gun ghatti, gum tragacanth, karaya gum, laminaran, locust bean gum, a methacrylate, a methyl methacrylate, modified starch, pectin, propylene glycol alginate, psyllium gum, polyvinyl pyrrolidone, rhamsan gum, scleroglucan (including clarified scleroglucan), starch, starch hydroxyethyl ether, starch dextrins and a xanthan gum, such as a clarified or low acetate or high pyruvate xanthan gum, and combinations thereof.

The amount of viscosity modulating agent included in the composition can be selected based on the desired viscosity of the composition. For example, a free flowing composition can require very low amounts of viscosity modulating agents, while a composition in the form of a non-flowing viscous gel can require significantly higher amounts of viscosity modulating agents. Generally, the viscosity modulating agent can be included in an amount from about 0 to about 25 wt %, or from about 0.1 wt % to about 10 wt %, or from about 0.5 wt % to about 5 wt %, by the total weight of the composition.

### Essential Oil

In some embodiments, the composition further comprises an essential oil that provides beneficial functions such as anti-bacteria, anti-fungal, anti-microbial, heat-relief, pain-relief, or skin-care. In some embodiments, the essential oil can serve as a synergist or functional enhancer described herein. Non-limiting examples of essential oil include aldehyde C16 (pure), a-terpineol, amyl cinnamic aldehyde, amyl salicylate, anisic aldehyde, benzyl alcohol, benzyl acetate, cuminaldehyde, cinnamaldehyde, cinnamic alcohol, carvacrol, carveol, citral, citronellal, citronellol, p-cymene, diethyl phthalate, dimethyl salicylate, dipropylene glycol, eucalyptol (cineole) eugenol, iso-eugenol, galaxolide, geraniol, guaiacol, ionone, menthol, methyl salicylate, methyl anthranilate, methyl ionone, methyl salicylate, a-pheliandrene, pennyroyal oil perillaldehyde, 1- or 2-phenyl ethyl alcohol, 1- or 2-phenyl ethyl propionate, piperonal, piperonyl acetate, piperonyl alcohol, D-pulegone, terpinen-4-ol, isopropyl myristate, terpinyl acetate, 4-tert-butylcyclohexyl acetate, thyme oil, thymol, lavender oil, rosemary oil, peppermint oil, neem oil, lemongrass oil, wintergreen oil, clove extract, metabolites of trans-anethole, vanillin, ethyl vanillin, linalool oil, and combinations thereof in any proportion.

In some embodiments, the essential oil is selected from the group comprising cuminaldehyde, cinnamaldehyde, cinnamic alcohol, carvacrol, carveol, citral, citronellal, citronellol, thyme oil, thymol, lavender oil, rosemary oil, peppermint oil, neem oil, lemongrass oil, wintergreen oil, clove extract, metabolites of trans-anethole, vanillin, ethyl vanillin, linalool oil, and combinations thereof in any proportion.

In some embodiments, the essential oil is present in less than a 1:5 (w/w) ratio with nootkatone, less than a 2:5 (w/w) ratio with nootkatone, less than a 3:5 (w/w) ratio with nootkatone, less than a 4:5 (w/w) ratio with nootkatone, or about at a 1:1 (w/w) ratio with nootkatone, or more than a 2:1 (w/w) ratio with nootkatone, or more than a 3:1 (w/w) ratio with nootkatone, or more than a 4:1 (w/w) ratio with nootkatone, or more than a 5:1 (w/w) ratio with nootkatone. In some embodiments, the essential oil has a content from about 0 to about 20 wt %, or from about 1 wt % to about 12 wt %, or from about 2 wt % to about 8 wt %, or from about 3 wt % to about 7 wt %, or from about 4 wt % to about 6 wt %, based on the total weight of the composition.

### Fragrance

In some embodiments, the composition further comprises a fragrance. In some embodiments, the fragrance can serve as a synergist or functional enhancer described herein. Non-limiting examples of fragrance agent or agents imparting a pleasant odor include carvacrol, cymene, cineol, eugenol, thymol, menthol, citral, and limonene.

In some embodiments, the composition further comprises a fragrance or flavor substance or an agent imparting a pleasant odor. Non-limiting examples of the flavor substance includes fruit ester, damascenone, alpha-ionone, beta-ionone, raspberry ketone, furanone derivative, limonene, linalool, phenylacetaldehyde, 2-phenylethanol, maltol, vanillin, linalool oil, eugenol, anethol, anise alcohol, anisaldehyde, guajakol, cinnamyl alcohol, cinnamaldehyde, citral, citronellal, citronellol, nerol, geraniol, ethylvanillin, benzyl alcohol, anisaldehyde, cinnamyl ester, benzyl ester, damascone, diacetyl, dihydrocoumarin, beta-dihydroionone, dimethyl anthranilate, methyl anthranilate, ethylmaltol, heliotropin, cis-3-hexenyl ester, ethyl decadienoate, methyl dihydrojasmorvate, methyl cinnamate, ethyl cinnamate, p-mentha-8-thiol-3-one, rose oxide, ketoisophorone, and combinations thereof in any proportion. It is noted that some of the solvents and essential oils described herein may also function as a fragrance.

In some embodiments, the essential oil is present in less than a 1:50 (w/w) ratio with nootkatone, less than a 1:30 (w/w) ratio with nootkatone, less than a 1:20 (w/w) ratio with nootkatone, less than a 1:10 (w/w) ratio with nootkatone, or less than about at a 1:5 (w/w) ratio with nootkatone. In some embodiments, the essential oil has a content from about 0 to about 10 wt %, or from about 1 wt % to about 8 wt %, or from about 2 wt % to about 6 wt %, or from about 3 wt % to about 5 wt %, based on the total weight of the composition.

### Preservative

In some applications, the compositions provided herein can include a preservative. In some embodiments, the preservative can also serve as a synergist or functional enhancer described herein. Any preservative known in the art can be included in the compositions. Exemplary preservatives include preservatives selected from among azoles, benzisothiazolin-3-one, benzalkonium quaternary compounds, benzyl alcohol, borates, 2-bromo-2-nitro-propane-1, 3-diol, butylparaben, 5-chloro-2-methyl-4-isothiazolin-3-one, chlorphenesin, chloroxylenol, diazolidinyl urea, a dimethyl-benzylalkyl-ammonium chloride, ethylparaben, formaldehyde, glutaraldehyde, halogenated salicylanilides, hexachlorophene, hexylene glycol, isobutylparaben, isothiazolin-3-one, 2-methyl-4-isothiazoline-3-one, methylchloro-isothiazolinone, methylisothiazolinone, methylparaben, monochloracetamide, neomycin sulfate, o-phenylphenol and salts thereof, phenoxyethanol, propionic acid and salts thereof, propylparaben, sodium benzoate, sorbic acid and salts thereof, tebuconazole and triazoles, and combinations thereof. Some preservatives are more potent or effective than others, as is known in the art. When present, the preservative can be present in an amount of about 0 to about 5 wt %, by weight, of the composition. For example, the preservative can be present in the composition in an amount of about 0.001% to about 2.5%, by weight, of the composition or in an amount of about 0.01 wt % to about 1 wt %, by weight, of the composition.

### Anti-Oxidant

An anti-oxidant can be included in the composition, e.g., to increase the length of time the deployed composition can be exposed to the environment or to decrease any negative impact oxygen or free radical thereof can have on the compositions. In some embodiments, the anti-oxidant can serve as a synergist or functional enhancer described herein. Exemplary anti-oxidants that can be included in the compositions provided herein include, but are not limited to, ascorbyl palmitate, butylated p-cresol, tert-butylhydroquinone, butylated hydroquinone monomethyl ether, butylhydroxyanisole, butylhydroxytoluene, propyl gallate, tocopherol, ascorbic acid, dibutyl-hydroxy toluene, dihydroquercetin, octyl gallate, dodecyl gallate, ethoxyquin, mixed tocopherols, octadecyl-3-(3,5-ditertiary butyl-4-hydroxy-phenyl) propionate, pentaerythritol-tetrakis[3-(3,5-ditertiary butyl-4-hydroxyphenyl)-propionate], 2,5-ditertiary butyl hydroquinone, 4,4′-thiobis(3-methyl-6-tertiary butyl phenol) and 2,2′-methylene-bis-(4-methyl-6-tertiary butyl phenol), and combinations thereof. Typically, an antioxidant can be included in the provided compositions in a protective amount, typically the lowest effective amount, such as, but are not limited to, between about 0 to about 5 wt %, between about 0.001 wt % to about 2.5 wt %, or between about 0.01 wt % to about 1 wt %, by weight, of the composition.

### Additional Active Ingredient

In some embodiments, the present composition further includes an additional active ingredient. The additional active ingredient may be a second insect or bug repelling compound, an insecticide, or a pesticide. Examples of active ingredients that repel insects and bugs are N,N-diethyl-meta-toluamide (DEET), picaridin (2-(2-hydroxyethyl)-1-piperidinecarboxylic acid 1-methylpropyl ester), citronella oil, camphor oil, cedarwood oil, coumarin, 2-hydroxy-methylcyclohexyl acetic acid lactone, beta-alanine, 2-hydroxymethyl-cyclohexylidene acetic acid lactone, 2-hydroxy-methylcyclohexyl propionic acid lactone, p-menthane-3,8-diol, and 3-[N-butyl-N-acetyl]-aminopropionic acid ethyl ester and combinations thereof. The additional active ingredient can be present in an amount of from about 0 to about 25 wt % by weight of the composition.

In some applications, the present composition is free or substantially free from an additional active ingredient as described herein. In one particular example, the present composition is free or substantially free from DEET.

### Additional Ingredients

In some embodiments, the compositions and formulations provided herein include one or more additional ingredient, such as colorant, synergist, functional enhancer, biologically active ingredient, or combinations thereof.

In some applications, the compositions provided herein can include a colorant. The colorant can provide additional visual cues to the applier of the composition, such as to help the applier see where the composition is being applied to a surface or locus and thereby identifying a coverage are and/or allowing an even distribution of the composition on a surface. Any colorant known in the art can be included in the compositions provided herein. Exemplary colorants for use in the provided compositions and formulations include, but are not limited to, dyes and pigments, such as titanium oxide, titanium dioxide, zinc oxide, white lead, zinc sulfide, aluminum oxide, iron oxide, silicon oxide, zirconium oxide, an azo-type colorant, a condensate-type colorant, a phthalocyanine-type colorant, a quinacridone-type colorant, an insoluble lake pigment, organic dyes, such as alizarin dyes, azo dyes, or metal phthalocyanine dyes.

Synergists and functional enhancers are ingredients that provide additional advantages or benefits when used together with nootkatone. In some examples, the provided compositions contain synergists that act to increase or prolong the effects of nootkatone or the nootkatone-containing compositions without increasing the amount of active ingredient. In some examples, the synergists and functional enhancers improves the solubility, durability, or compatibility of nootkatone in the composition either in storage or when applied. In some examples, the synergists and functional enhancers can enhance the advantage or function provided by other ingredients/components described herein, such as essential oil, solvent, dispersing agent, fragrance, preservative, anti-oxidant, viscosity modulating agent, flavoring substances, etc. Examples of suitable synergists and functional enhancers for use in the compositions include, but are not limited to, benzyl alcohol, dimethyl phthalate, diethyl phthalate, butyl phthalate, p-menthane-3,8-diol (PMD), vanillin, Eugenol, Citral, linalool, terpene-oil or terpene derivatives, cuminaldehyde, thyme oil, clove oil, oil of Lemon Eucalyptus (OLE), aloe, vitamin, bis-(2,3,3,3-tetrachloropropyl)ether, dodecyl imidazole, N-(2-ethylhexyl)bicyclo-[2,2, 1]hept-5-ene-2,3-dicarboxyimide piperonyl butoxide, isobornyl thiocyanatoacetate, safroxan, and sesamex.

When present in the compositions, the additional ingredient can be included at any concentration necessary to impart the desired or targeted property to the composition. In general, the additional ingredient can be present in an amount of about 0.0001 wt % to about 1 wt %, by weight, of the composition. In some applications, the additional ingredient is present in an amount of about 0.0005 wt % to about 0.5 wt %, by weight, of the composition.

### Formulation

An exemplary composition provided herein includes nootkatone, a combination of nootkatone and an analog or nootkatone, or an analog of nootkatone, and a carrier. For example, the carrier in the composition can be present in an amount at or about 0.1 wt % to about 90 wt %, or greater than 90 wt %, or from about 90 wt % to about 99 w1%, based on the weight of the composition.

For example, provided are compositions that include from about 0.1 wt % to at or about 10 wt % nootkatone, or greater than 10 wt %, or greater than 15 wt %, or greater than 10 wt %, or greater than 25 wt % nootkatone and/or a derivative or analog thereof, from at or about 1 wt % to at or about 90 wt % carrier. The compositions can include other ingredients, such as antioxidants, solvent, essential oil, dispersing agents, surfactants, viscosity modulating agents, preservatives, synergist or functional enhancer, and additional ingredients, or a combination thereof. For example, a dispersing agent can be present in an amount of from about 0.005 wt % up to about 50 wt % by weight of the composition, replacing an equivalent amount of carrier.

The compositions can include a derivative or analog of nootkatone in addition to or in place of the nootkatone. Any analog or derivative of nootkatone known in the art or that can be prepared can be included in the compositions provided herein. Examples of derivatives or analogs of nootkatone include, but are not limited to, nootkatone-11,12-epoxide, nootkatone-1,10-epoxide, nootkatone-1,10-11, 12-diepoxide, tetrahydro-nootkatone and 1,10-dihydronootkatone and combinations thereof.

In certain embodiments, the composition is free or substantially free from water, and is non-aqueous. In such embodiments, the composition is a clear or substantially clear liquid, with a turbidity value of about 30 NTU or less, about 20 NTU or less, about 10 NTU or less, about 5 NTU or less, or about 1 NTU or less, wherein, NTU represents Nephelometric Turbidity Units. Comparatively, nootkatone-containing emulsions typically contain a mixture of water, organic solvent, and an emulsifier. Emulsions are not visually clear in appearance and often have a turbidity significantly higher than 30 NTU.

In one particular embodiment, a bug or insect repellent composition according to the present disclosure consists essentially of: from about 1 wt % to about 10 wt % of nootkatone; from about 1 wt % to about 20 wt % of a solvent; from about 1 wt % to about 10 wt % of a dispersing agent; and from about 60 wt % to about 97 wt % of a carrier.

In some embodiments, a bug or insect repellent composition according to the present disclosure consists essentially of nootkatone or a derivative or analogue thereof, a carrier, a dispersing agent, and a solvent. In one particular example, a bug or insect repellent composition according to the present disclosure consists essentially of: from about 2 wt % to about 8 wt % of nootkatone; from about 2 wt % to about 15 wt % of a solvent; from about 2 wt % to about 8 wt % of a dispersing agent; and from about 69 wt % to about 94 wt % of a carrier. In another particular example, a bug or insect repellent composition according to the present disclosure consists essentially of: from about 3 wt % to about 6 wt % of nootkatone; from about 3 wt % to about 10 wt % of a solvent; from about 3 wt % to about 6 wt % of a dispersing agent; and from about 78 wt % to about 91 wt % of a carrier. In another particular example, a bug or insect repellent composition according to the present disclosure consists essentially of: from about 3 wt % to about 5 wt % of nootkatone; from about 4 wt % to about 8 wt % of a solvent; from about 3 wt % to about 5 wt % of a dispersing agent; and from about 82 wt % to about 90 wt % of a carrier. In some embodiments, the carrier is selected from the group comprising 1-propanol, 2-propanol (isopropyl alcohol), 1-butanol, 2-butanol, 2-methyl-1-propanol, 1-pentanol, 2-pentanol, 3-methyl-1-butanol, 3-methyl-2-butanol, ethylene glycol, propylene glycol, 1,4-butanediol, 1,3-butanediol, and combinations thereof in any proportion. In some embodiments, the dispersing agent is a polymer selected from the group comprising of poly(vinyl pyrrolidone), polyacrylate, poly(acrylic acid), poly(ethylene glycol), poly(vinyl alcohol), poly(vinyl acetate), polyacrylate carboxy late copolymer, styrene acrylic acid copolymer, alkyl-polyglucoside, and combinations thereof in any proportion. In some embodiments, the solvent is selected from the group comprising benzyl alcohol, dimethyl phthalate, diethyl phthalate, butyl phthalate, and combinations thereof in any proportion.

In some embodiments, a bug or insect repellent composition according to the present disclosure consists essentially of: from about 3 wt % to about 7 wt % of nootkatone; from about 4 wt % to about 12 wt % of benzyl alcohol; from about 1 wt % to about 5 wt % of poly(vinyl pyrrolidone); and from about 76 wt % to about 92 wt % of isopropyl alcohol. In certain embodiments, a bug or insect repellent composition according to the present disclosure consists essentially of: from about 3 wt % to about 6 w1% of nootkatone; from about 3 wt % to about 10 wt % of benzyl alcohol; from about 2 wt % to about 6 wt % of poly(vinyl pyrrolidone); and from about 78 wt % to about 92 wt % of isopropyl alcohol. In another particular example, a bug or insect repellent composition according to the present disclosure consists essentially of: from about 3 wt % to about 5 wt % of nootkatone; from about 4 wt % to about 8 wt % of benzyl alcohol; from about 2 wt % to about 5 wt % of poly(vinyl pyrrolidone); and from about 82 wt % to about 91 wt % of isopropyl alcohol.

In a particular embodiment, a bug or insect repellent composition according to the present disclosure consists essentially of about 4 wt % of nootkatone, about 10 wt % benzyl alcohol, about 2 wt % of poly(vinyl pyrrolidinone), and about 84 wt % of isopropyl alcohol. In yet another embodiment, a bug or insect repellent composition according to the present disclosure consists essentially of about 6 wt % of nootkatone, about 5 wt % benzyl alcohol, about 2 wt % of poly(vinyl pyrrolidinone), and about 87 wt % of isopropyl alcohol.

In some embodiments, a bug or insect repellent composition according to the present disclosure consists essentially of nootkatone or a derivative or analogue thereof, a carrier, a synergist or functional enhancer, and a solvent. In one particular example, a bug or insect repellent composition according to the present disclosure consists essentially of: from about 2 wt % to about 8 wt % of nootkatone; from about 2 wt % to about 15 wt % of a solvent; from about 2 wt % to about 8 wt % of a synergist or functional enhancer; and from about 69 wt % to about 94 wt % of a carrier. In another particular example, a bug or insect repellent composition according to the present disclosure consists essentially of: from about 3 wt % to about 6 wt % of nootkatone; from about 3 wt % to about 10 wt % of a solvent; from about 3 wt % to about 6 wt % of a synergist or functional enhancer; and from about 78 wt % to about 91 wt % of a carrier. In another particular example, a bug or insect repellent composition according to the present disclosure consists essentially of: from about 3 wt % to about 5 wt % of nootkatone; from about 4 wt % to about 8 wt % of a solvent; from about 3 wt % to about 5 wt % of a synergist or functional enhancer; and from about 82 wt % to about 90 wt % of a carrier. In some embodiments, the carrier is selected from the group comprising 1-propanol, 2-propanol (isopropyl alcohol), 1-butanol, 2-butanol, 2-methyl-1-propanol, 1-pentanol, 2-pentanol, 3-methyl-1-butanol, 3-methyl-2-butanol, ethylene glycol, propylene glycol, 1,4-butanediol, 1,3-butanediol, and combinations thereof in any proportion. In some embodiments, the synergist or functional enhancer is selected from the group comprising p-menthane-3,8-diol (PMD), vanillin, Eugenol, Citral, linalool, terpene-oil or terpene derivatives, cuminaldehyde, thyme oil, clove oil, oil of Lemon Eucalyptus (OLE), and combinations thereof in any proportion. In some embodiments, the solvent is selected from the group comprising benzyl alcohol, dimethyl phthalate, diethyl phthalate, butyl phthalate, and combinations thereof in any proportion.

In some embodiments, a bug or insect repellent composition according to the present disclosure consists essentially of nootkatone or a derivative or analogue thereof, a carrier, a synergist or functional enhancer, a dispersing agent, and a solvent. In one particular example, a bug or insect repellent composition according to the present disclosure consists essentially of: from about 2 wt % to about 8 wt % of nootkatone; from about 2 wt % to about 15 wt % of a solvent; from about 2 wt % to about 8 wt % of an a synergist or functional enhancer; from about 2 wt % to about 8 wt % of a dispersing agent, and from about 61 wt % to about 92 wt % of a carrier. In another particular example, a bug or insect repellent composition according to the present disclosure consists essentially of: from about 3 wt % to about 6 wt % of nootkatone; from about 3 wt % to about 10 wt % of a solvent; from about 3 wt % to about 6 wt % of a synergist or functional enhancer; from about 2 wt % to about 6 wt % of a dispersing agent, and from about 72 wt % to about 89 wt % of a carrier. In another particular example, a bug or insect repellent composition according to the present disclosure consists essentially of: from about 3 wt % to about 5 wt % of nootkatone; from about 4 wt % to about 8 wt % of a solvent; from about 3 wt % to about 5 wt % of a synergist or functional enhancer; from about 2 wt % to about 5 wt % of a dispersing agent; and from about 77 wt % to about 88 w1% of a carrier. In some embodiments, the carrier is selected from the group comprising 1-propanol, 2-propanol (isopropyl alcohol), 1-butanol, 2-butanol, 2-methyl-1-propanol, 1-pentanol, 2-pentanol, 3-methyl-1-butanol, 3-methyl-2-butanol, ethylene glycol, propylene glycol, 1,4-butanediol, 1,3-butanediol, and combinations thereof in any proportion. In some embodiments, the synergist or functional enhancer is selected from the group comprising p-menthane-3,8-diol (PMD), vanillin, Eugenol, Citral, linalool, terpene-oil or terpene derivatives, cuminaldehyde, thyme oil, clove oil, oil of Lemon Eucalyptus (OLE), and combinations thereof in any proportion. In some embodiments, the dispersing agent is a polymer selected from the group comprising of poly(vinyl pyrrolidone), polyacry late, poly(acrylic acid), poly(ethylene glycol), poly(vinyl alcohol), poly(vinyl acetate), polyacrylate carboxy late copolymer, styrene acrylic acid copolymer, alkyl-polyglucoside, and combinations thereof in any proportion. In some embodiments, the solvent is selected from the group comprising benzyl alcohol, dimethyl phthalate, diethyl phthalate, butyl phthalate, and combinations thereof in any proportion.

### Usable/Applicable Compositions and Products

The compositions provided herein containing nootkatone or a derivative or analog thereof can contain a liquid carrier and be formulated for delivery using a pump spray. In some applications, the composition includes a carrier containing an alcohol, ether, ester, ketone, aldehyde, oil or water or combinations thereof to provide a solution of relatively low viscosity that can be dispensed using a pump spray. Such compositions can be used as a spray for topical application to a surface or space, such as human skin, space surrounding the target subject, clothing, bedding, furniture, equipment, human belongs, and so on.

In some examples, other carriers can be included in the composition. For example, an exemplary composition contains from at or about 1% to at or about 10%, or greater than 10% nootkatone and/or a derivative or analog thereof, by weight, of the composition, and the balance of the composition contains a carrier selected from among water, an alcohol, an aldehyde, an alkane, an alkene, an amide, an amine, a diglyceride, an ester, an ether, a glycol ether, a fat, a fatty acid, a glycol ester, a ketone, lanolin, mineral oil, a silicone or silicone oil, paraffin oil, a monoglyceride, a polyethylene glycol, petrolatum, a propylene carbonate, a N-methyl pyrrolidone, a g-butyrolactone, a dipropylene glycol monomethyl ether, tall oils, a terpene hydrocarbon, a terpene alcohol, a triglyceride, finely divided organic solid material, finely divided inorganic solid materials and mixtures thereof.

The sprays can be formulated to include viscosity modifiers so that the composition adheres to the target location or the targeted insect/bugs. The composition also can include a penetration agent when the spray is intended for application directly onto the insect or bug, such as for sprays directed to controlling ants, ticks, fleas, roaches, wasps, hornets, bed bugs, or motes. Any penetration agents known in the art can be included. Exemplary penetration agents include silicone dioxide, petroleum distillate, light solvent naphtha or D-limonene or combinations thereof.

The compositions provided herein can contain a gas carrier, such as a gas propellant, and be formulated for use in aerosol devices. A propellant can be included in the carrier when the composition is to be used in aerosol devices. Aerosol devices are known in the art (see, e.g., U.S. Pat. Nos. 3,915,343, 3,884,828, 3,970,584, 4,062,937, and 6,415,992). Most aerosol products contain the active ingredient and the propellant. Examples of suitable gas propellants include propane, n-butane, isobutane, ethylene, dimethyl ether, nitrogen, nitrous oxide, carbon dioxide and mixtures thereof.

The compositions provided herein also can be included in a personal care or cosmetic composition. For example, a composition containing a 25:1, 20:1, 15:1, 14:1, 13:1, 12:1, 11:1, 10:1, 9:1, 8:1, 7:1, 6:1, 5:1, 4:1, 3:1, 2:1, 1:1, 1:2, 1:3, 1:4, 1:5, 1:6, 1:7, 1:8. 1:9, 1:10, 1:11, 1:12, 1:13, 1:14, 1:15, 1:20 or 1:25 mixture of nootkatone and/or a derivative or analog thereof to a carrier, such as an alcohol, aldehyde, ketone, ester, oil or ether or combinations thereof, can be prepared and added to a standard personal care or cosmetic formulation to deliver the nootkatone and/or a derivative or analog thereof. Representative formulations to which the nootkatone and/or a derivative or analog thereof can be added include insect repellents, skin care products, hair care products, and cleansing products.

In some applications, the nootkatone and/or a derivative or analog thereof can be mixed with a carrier prior to incorporating the composition into the formulation or onto or into a woven or nonwoven substrate. The ratio of nootkatone and/or analog thereof to carrier can vary, such as 25:1, 20:1, 15:1, 14:1, 13:1, 12:1, 11:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:11, 1:12, 1:13, 1:14, 1:15, 1:20 or 1:25. When present, a nonwoven substrate can be a flexible sheet that includes fibers, which can be adhesively or thermally bonded. The fibers can be of any material, such as cellulose, cellulose ester, cotton, hemp, jute, linen, ramie, rayon, polyamides, polyesters polyolefins, polypropylene, polyvinyl derivatives, silk, sisal and wool and combinations thereof.

Any of the insect repellent composition provided herein can be used to repel an insect or a bug selected from among Siphonaptera insects, such as cat flea (Ctenocephalides felis), dog flea (Ctenocephalides canis), oriental rat flea (Xenopsylla cheopis), human flea (Pulex irritans), chigoe (Tunga penetrans) and European rat flea (Nosopsyllusfasciatus); Anoplura insects, such as Head louse (Pediculus humanus capitis), crab louse (Pthirus pubis), short-nosed cattle louse (Haematopinus eurysternus), sheep louse (Dalmalinia ovis), hog louse (Haematopinus suis), long-nosed cattle louse (Linognathus vituli), cattle biting louse (Bovicola bovis), poultry shaft louse (Menopon gallinae), poultry body louse (Menacanthus stramineus), little blue cattle louse (Solenopotes capillatus), Haematopinus spp., Linognathus spp., Pediculus spp., Phtirus spp. and Solenopotes spp.; Acarina insects, such as bush tick (Haemaphysalis longicomis), Haemaphysalis flava, Dermacentor taiwanicus, American dog tick (Dermacentor variabilis), Ixodes ovatus, Ixodes persulcatus, black legged tick (Ixodes scapularis), lone star tick (Amblyomma americanum), Boophilus microplus, Rhipicephalus sanguineus, Ixodes holocyclus, western black legged tick (Ixodes pacificus), Deer ticks (Ixodes Ricinus), Dermacentor andersoni, Ambgyomma maculatum, ear mite (Octodectes cynotis), Psoroptes spp., Chorioptes spp., Otodectes spp., Sarcoptes spp., Notoedres spp., Knemidocoptes spp., Sacroptes scabiei, Demodex spp., follicle mite (Demodex canis), northern fowl mite (Ornithonyssus sylviarum), poultry red mite (Dermanyssus gallinae), Trombicula spp., Leptotrombidium akamushi, Ornithodorus hermsi, Ornithodorus turicata, Ornithonyssus bacoti, Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Cytodites spp. and Laminosioptes spp.; Heteroptera insects, such as common bedbug (Cimex lectularius), tropical bedbug (Cimex hemipterus), Reduvius senilis, Triatoma spp. Rhodnius spp., Panstrongylus spp., and Arilus critatus; and Mallophage (Amblycera and Ischnocera) insects, such as Trimenopon spp., Menopon spp., Trinoton spp., Bovicola spp., Werneckiella spp., Lepikentron spp., Trichodectes spp. and Felicola spp.

The insect/bug repellent can be provided as a packaged product. For example, the package can include a container holding any of the compositions provided herein containing nootkatone and/or a derivative or analog thereof, or an absorbent sheet impregnated a composition provided herein. The insect/bug repellent can be provided as an aerosol propellant pressurized spray, which contains any one of the compositions provided herein and at least at or about 5% to 90% propellant by weight of the composition. Any propellant commonly used in the art for preparation or aerosol sprays can be included in the compositions. For example, the propellant can include carbon dioxide, nitrous oxide, propane, butane or a mixture thereof.

### Preparation of the Compositions and Formulations

The compositions provided herein can be produced using methods known to the skilled artisan. For example, in compositions in which all of the ingredient are liquids and have similar polarities such that when combined they readily form a solution or dispersion, the compositions can be prepared by mixing the components together, such as using a paddle mixer or lightning mixer.

In some applications, one or more of the components of the composition can be solid at room temperature but melts at elevated temperatures to form a liquid. In cases where one of the components needs to be heated in order to incorporate them into the composition, the ingredients to be heated generally can be segregated from the nootkatone or derivative or analog thereof, which is volatile. For example, an ingredient to be heated can be mixed in a jacketed vessel while heating until liquified, and then the carrier and any optional components can be incorporated with constant mixing. The temperature of the resulting mixture then can be reduced to room temperature or slightly higher (such as 25° C.) and the nootkatone and/or derivative or analog thereof added with constant mixing until incorporated.

In one particular embodiment, a method of preparing a composition comprising: mixing nootkatone, a solvent, a dispersing agent, and a carrier to form the composition, wherein the comprising consists essentially of from about 1 wt % to about 10 wt % of nootkatone; from about 1 wt % to about 20 wt % of the solvent; from about 1 wt % to about 10 wt % of the dispersing agent; and from about 60 wt % to about 97 wt % of the carrier. In one embodiment, the solvent is benzyl alcohol, the dispersing agent is poly(vinyl pyrrolidinone), the carrier is isopropyl alcohol.

In one particular embodiment, a method of preparing a composition comprising: mixing nootkatone, a synergist or functional enhancer, a solvent, and a carrier to form the composition, wherein the comprising consists essentially of from about 1 wt % to about 10 wt % of nootkatone; from about 1 wt % to about 20 wt % of the solvent; from about 1 wt % to about 10 wt % of the synergist or functional enhancer; and from about 60 wt % to about 97 wt % of the carrier. In one embodiment, the solvent is benzyl alcohol, the synergist or functional enhancer is selected from p-menthane-3,8-diol (PMD), vanillin, Eugenol, Citral, linalool, terpene-oil or terpene derivatives, cuminaldehyde, thyme oil, clove oil, oil of Lemon Eucalyptus (OLE), and combinations thereof in any proportion, and the carrier is isopropyl alcohol.

In one particular embodiment, a method of preparing a composition comprising: mixing nootkatone, a synergist or functional enhancer, a solvent, a dispersing agent, and a carrier to form the composition, wherein the comprising consists essentially of from about 1 wt % to about 10 wt % of nootkatone; from about 1 wt % to about 20 wt % of the solvent; from about 1 wt % to about 10 wt % of the synergist or functional enhancer; from about 1 wt % to about 10 wt % of the dispersing agent, and from about 50 wt % to about 96 wt % of the carrier. In one embodiment, the solvent is benzyl alcohol, the synergist or functional enhancer is selected from p-menthane-3,8-diol (PMD), vanillin, Eugenol, Citral, linalool, terpene-oil or terpene derivatives, cuminaldehyde, thyme oil, clove oil, oil of Lemon Eucalyptus (OLE), and combinations thereof in any proportion, and the carrier is isopropyl alcohol.

In another embodiment, a method of preparing a composition comprising mixing about 4 wt % of nootkatone, about 10 wt % benzyl alcohol, about 2 wt % of poly(vinyl pyrrolidinone), and about 84 wt % of isopropyl alcohol to form the composition. In yet another embodiment, a method of preparing a composition comprising mixing about 6 wt % of nootkatone, about 5 wt % benzyl alcohol, about 2 wt % of poly(vinyl pyrrolidinone), and about 87 wt % of isopropyl alcohol to form the composition.

### Methods of Using

In another aspect, the present disclosure provides a method of repelling an insect or a bug. The method comprises applying any one of the composition described herein on a surface, whereby the insect is repelled from attaching to the surface.

In some embodiments, the methods include providing a composition provided herein to a location, where the composition contains from about 0.1 wt % to about 10 wt %, or greater than 10 wt %, or greater than 15 wt %, or greater than 20 wt %, or greater than 25 wt % nootkatone and/or a derivative or analog of nootkatone; and deploying the composition at the location in an effective amount to repel insects/bugs or prevent insects/bugs from attaching to the location or kill insect/bugs, where the insects or bugs are repelled when the insects or bugs come into contact with the composition or vapors from the composition. The deploying step can include atomizing, brushing on, coating, dipping, drenching, dripping, dusting, foaming, infusing, injecting into or onto, pouring, rolling on, scattering, spraying, spreading, sprinkling or wiping the composition onto at least a portion of the location. The amount of nootkatone required to repel and/or kill an insect or bug can be determined empirically and will depend on the targeted insect or bug. For some insects or bugs, a composition containing from about 0.1 wt % to about 10 wt %, or greater than 10 wt %, or greater than 15 wt %, or greater than 20 wt %, or greater than 25 wt % nootkatone and/or analog or derivative of nootkatone is an insect or bug repelling and/or killing amount.

Various modifications of the method can be made, such as modifying the amount of nootkatone and/or derivative or analog thereof in the composition. In some methods, the composition includes at or about or at least 0.5 wt %, 0.75 wt %, 1 wt %, 1.05 wt %, 1.1 wt %, 1.15 wt %, 1.2 wt %, 1.25 wt %, 1.3 wt %, 1.35 wt %, 1.4 wt %, 1.45 wt %, 1.5 wt %, 1.55 wt %, 1.6 wt %, 1.65 wt %, 1.7 wt %, 1.75 wt %, 1.8 wt %, 1.85 wt %, 1.9 wt %, 1.95 wt %, 2 wt %, 2.05 wt %, 2.1 wt %, 2.15 wt %, 2.2 wt %, 2.25 wt %, 2.3 wt %, 2.35 wt %, 2.4 wt %, 2.45 wt %, 2.5 wt %, 2.55 wt %, 2.6 wt %, 2.65 wt %, 2.7 wt %, 2.75 wt %, 2.8 wt %, 2.85 wt %, 2.9 wt %, 2.95 wt %, 3 wt %, 3.05 wt %, 3.1 wt %, 3.15 wt %, 3.2 wt %, 3.25 wt %, 3.3 wt %, 3.35 wt %, 3.4 wt %, 3.45 wt %, 3.5 wt %, 3.55 wt %, 3.6 wt %, 3.65 wt %, 3.7 wt %, 3.75 wt %, 3.8 wt %, 3.85 wt %, 3.9 wt %, 3.95 wt %, 4 wt %, 4.05 wt %, 4.1 wt %, 4.15 wt %, 4.2 wt %, 4.25 wt %, 4.3 wt %, 4.35 wt %, 4.4 wt %, 4.45 wt %, 4.5 wt %, 4.55 wt %, 4.6 wt %, 4.65 wt %, 4.7 wt %, 4.75 wt %, 4.8 wt %, 4.85 wt %, 4.9 wt %, 4.95 wt %, 5 wt %, 5.05 wt %, 5.1 wt %, 5.15 wt %, 5.2 wt %, 5.25 wt %, 5.3 wt %, 5.35 wt %, 5.4 wt %, 5.45 wt %, 5.5 wt %, 5.55 wt %, 5.6 wt %, 5.65 wt %, 5.7 wt %, 5.75 wt %, 5.8 wt %, 5.85 wt %, 5.9 wt %, 5.95 wt %, 6 wt %, 6.05 wt %, 6.1 wt %, 6.15 wt %, 6.2 wt %, 6.25 wt %, 6.3 wt %, 6.35 wt %, 6.4 wt %, 6.45 wt %, 6.5 wt %, 6.55 wt %, 6.6 wt %, 6.65 wt %, 6.7 wt %, 6.75 wt %, 6.8 wt %, 6.85 wt %, 6.9 wt %, 6.95 wt %, 7 wt %, 7.05 wt %, 7.1 wt %, 7.15 wt %, 7.2 wt %, 7.25 wt %, 7.3 wt %, 7.35 wt %, 7.4 wt %, 7.45 wt %, 7.5 wt %, 7.55 wt %, 7.6 wt %, 7.65 wt %, 7.7 wt %, 7.75 wt %, 7.8 wt %, 7.85 wt %, 7.9 wt %, 7.95 wt %, 8 wt %, 8.05 wt %, 8.1 wt %, 8.15 wt %, 8.2 wt %, 8.25 wt %, 8.3 wt %, 8.35 wt %, 8.4 wt %, 8.45 wt %, 8.5 wt %, 8.55 wt %, 8.6 wt %, 8.65 wt %, 8.7 wt %, 8.75 wt %, 8.8 wt %, 8.85 wt %, 8.9 wt %, 8.95 wt %, 9 wt %, 9.05 wt %, 9.1 wt %, 9.15 wt %, 9.2 wt %, 9.25 wt %, 9.3 wt %, 9.35 wt %, 9.4 wt %, 9.45 wt %, 9.5 wt %, 9.55 wt %, 9.6 wt %, 9.65 wt %, 9.7 wt %, 9.75 wt %, 9.8 wt %, 9.85 wt %, 9.9 wt %, 9.95 wt %, 10 wt %, 10.05 wt %, 10.1 wt %, 10.15 wt %, 10.2 wt %, 10.25 wt %, 10.3 wt %, 10.35 wt %, 10.4 wt %, 10.45 wt %, 10.5 wt %, 10.55 wt %, 10.6 wt %, 10.65 wt %, 10.7 wt %, 10.75 wt %, 10.8 wt %, 10.85 wt %, 10.9 wt %, 10.95 wt %, 11 wt %, 11.05 wt %, 11.1 wt %, 11.15 wt %, 11.2 wt %, 11.25 wt %, 11.3 wt %, 11.35 wt %, 11.4 wt %, 11.45 wt %, 11.5 wt %, 11.55 wt %, 11.6 wt %, 11.65 wt %, 11.7 wt %, 11.75 wt %, 11.8 wt %, 11.85 wt %, 11.9 wt %, 11.95 wt %, 12 wt %, 12.05 wt %, 12.1 wt %, 12.15 wt %, 12.2 wt %, 12.25 wt %, 12.3 wt %, 12.35 wt %, 12.4 wt %, 12.45 wt %, 12.5 wt %, 12.55 wt %, 12.6 wt %, 12.65 wt %, 12.7 wt %, 12.75 wt %, 12.8 wt %, 12.85 wt %, 12.9 wt %, 12.95 wt %, 13 wt %, 13.05 wt %, 13.1 wt %, 13.15 wt %, 13.2 wt %, 13.25 wt %, 13.3 wt %, 13.35 wt %, 13.4 wt %, 13.45 wt %, 13.5 wt %, 13.55 wt %, 13.6 wt %, 13.65 wt %, 13.7 wt %, 13.75 wt %, 13.8 wt %, 13.85 wt %, 13.9 wt %, 13.95 wt %, 14 wt %, 14.05 wt %, 14.1 wt %, 14.15 wt %, 14.2 wt %, 14.25 wt %, 14.3 wt %, 14.35 wt %, 14.4 wt %, 14.45 wt %, 14.5 wt %, 14.55 wt %, 14.6 wt %, 14.65 wt %, 14.7 wt %, 14.75 wt %, 14.8 wt %, 14.85 wt %, 14.9 wt %, 14.95 wt %, 15 wt %, 15.05 wt %, 15.1 wt %, 15.15 wt %, 15.2 wt %, 15.25 wt %, 15.3 wt %, 15.35 wt %, 15.4 wt %, 15.45 wt %, 15.5 wt %, 15.55 wt %, 15.6 wt %, 15.65 wt %, 15.7 wt %, 15.75 wt %, 15.8 wt %, 15.85 wt %, 15.9 wt %, 15.95 wt %, 16 wt %, 16.05 wt %, 16.1 wt %, 16.15 wt %, 16.2 wt %, 16.25 wt %, 16.3 wt %, 16.35 wt %, 16.4 wt %, 16.45 wt %, 16.5 wt %, 16.55 wt %, 16.6 wt %, 16.65 wt %, 16.7 wt %, 16.75 wt %, 16.8 wt %, 16.85 wt %, 16.9 wt %, 16.95 wt %, 17 wt %, 17.05 wt %, 17.1 wt %, 17.15 wt %, 17.2 wt %, 17.25 wt %, 17.3 wt %, 17.35 wt %, 17.4 wt %, 17.45 wt %, 17.5 wt %, 17.55 wt %, 17.6 wt %, 17.65 wt %, 17.7 wt %, 17.75 wt %, 17.8 wt %, 17.85 wt %, 17.9 wt %, 17.95 wt %, 18 wt %, 18.05 wt %, 18.1 wt %, 18.15 wt %, 18.2 wt %, 18.25 wt %, 18.3 wt %, 18.35 wt %, 18.4 wt %, 18.45 wt %, 18.5 wt %, 18.55 wt %, 18.6 wt %, 18.65 wt %, 18.7 wt %, 18.75 wt %, 18.8 wt %, 18.85 wt %, 18.9 wt %, 18.95 wt %, 19 wt %, 19.05 wt %, 19.1 wt %, 19.15 wt %, 19.2 wt %, 19.25 wt %, 19.3 wt %, 19.35 wt %, 19.4 wt %, 19.45 wt %, 19.5 wt %, 19.55 wt %, 19.6 wt %, 19.65 wt %, 19.7 wt %, 19.75 wt %, 19.8 wt %, 19.85 wt %, 19.9 wt %, 19.95 wt %, 20 wt %, 21.05 wt %, 21.1 wt %, 21.15 wt %, 21.2 wt %, 21.25 wt %, 21.3 wt %, 21.35 wt %, 21.4 wt %, 21.45 wt %, 21.5 wt %, 21.55 wt %, 21.6 wt %, 21.65 wt %, 21.7 wt %, 21.75 wt %, 21.8 wt %, 21.85 wt %, 21.9 wt %, 21.95 wt %, 22 wt %, 22.05 wt %, 22.1 wt %, 22.15 wt %, 22.2 w1%, 22.25 wt %, 22.3 wt %, 22.35 wt %, 22.4 wt %, 22.45 wt %, 22.5 wt %, 22.55 wt %, 22.6 wt %, 22.65 wt %, 22.7 wt %, 22.75 wt %, 22.8 wt %, 22.85 wt %, 22.9 wt %, 22.95 wt %, 23 wt %, 23.05 wt %, 23.1 wt %, 23.15 wt %, 23.2 wt %, 23.25 wt %, 23.3 wt %, 23.35 wt %, 23.4 wt %, 23.45 wt %, 23.5 wt %, 23.55 wt %, 23.6 wt %, 23.65 wt %, 23.7 wt %, 23.75 wt %, 23.8 wt %, 23.85 wt %, 23.9 wt %, 23.95 wt %, 24 wt %, 24.05 wt %, 24.1 wt %, 24.15 wt %, 24.2 wt %, 24.25 wt %, 24.3 wt %, 24.35 wt %, 24.4 wt %, 24.45 wt %, 24.5 wt %, 24.55 wt %, 24.6 wt %, 24.65 wt %, 24.7 wt %, 24.75 wt %, 24.8 wt %, 24.85 wt %, 24.9 wt %, 24.95 wt % or 25 wt % nootkatone and/or an analog or derivative of nootkatone as an effective repelling and/or killing amount.

In some methods, the surface or location to which the composition is deployed is skin, hair or clothing a human. The composition can deployed by applying topically to the skin, hair, or clothing, and the composition can be provided as an aerosol, a solution, a spray, or a liquid. In some methods, the composition is provided in a form selected from among skin conditioners, hand/body/facial lotions, skin moisturizers, skin toners, skin sanitizers, skin cleansing compositions, skin soothing and lubricating compositions, sunscreen products, anti-aging products, tanning products, self-tanning products, after-sun products, masking products, anti-wrinkle products, hair conditioners, hair styling gels, hair anti-dandruff compositions, hair growth promoter compositions, hair lotions, hair tonics, rinses, conditioners, hair colorant compositions, hair anti-frizzing agent compositions, hair shining compositions, mousses, styling gels, hair pomade products and hair sprays, soaps, foaming bath products, hand/body/facial cleansers, astringent cleansers, anti-acne products, shampoos, body shampoos.

A particular method provided herein targets insects or bugs that have invaded a bedding location. In such methods, one or more of the compositions provided herein containing nootkatone and/or a derivative or analog thereof is deployed onto bedding (sheets, blankets, linen, pillows), bed boards, bed slats, a mattress, box springs, furniture, carpeting, baseboards or flooring or a combination thereof. The compositions can be deployed using any appropriate method, such as by atomizing, coating, dipping, drenching, dripping, dusting, foaming, infusing, injecting into or onto, pouring, rolling on, scattering, spraying, spreading, sprinkling or wiping. For example, in some methods deploying the composition includes spraying the composition on to the surface of bedding (sheet, linen, blanket, pillow), bed boards, bed slats, a mattress, box springs, furniture, carpeting, baseboards or flooring or a combination thereof. In some methods, the composition is injected into the interior of the targeted locus, such as the interior of a pillow, mattress, box springs, furniture, carpeting, baseboards or flooring or a combination thereof.

The locus selected for deploying the compositions provided herein can be determined based on the insect or bug targeted to be repelled and/or killed. For example, when the insect is a termite, a location for deploying a composition provided herein can include any wood structure, wooden object or wall space. For most insects or bugs, treatment of any one or more of the following locations can be effective to repel or kill the insect or bug; an air supply duct, an attic, an awning, a basement, a cellar, a crawlspace, a deck, a dock, a garage, a hamper, a heating vent, a home foundation, a linen storage closet, a pool deck, roof tiles, a shipping container, a storage unit, a suitcase, a walkway and a wall space. In the methods provided, the compositions provided herein can be deployed by any technique known in the art, such as by atomizing, coating, dipping, drenching, dripping, dusting, foaming, infusing, injecting into or onto, pouring, rolling on, scattering, spraying, spreading, sprinkling or wiping the composition onto or into at least a portion of the location.

When the locus to be treated is a surface, the compositions provided herein can be applied by spraying, wiping or dusting the surface. In some methods, the composition is deployed by providing it in a form of an absorbent substrate (such as a woven or nonwoven fabric or cellulosic material) or gel and positioning it in the location. The compositions for use in the methods herein can be formulated to release nootkatone over a given length of time, depending on the application area. For example, in some applications, the compositions provided herein used in the methods to repel and/or kill insects or bugs can be formulated for delivery of nootkatone and/or a derivative or analog of nootkatone for at least 15 minutes, 30 minutes, 1 hour, 2 hours, 3 hours, 4 hours, 5 hours, 6, hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, or at least 1 day, or at least 2 days, or at least 3 days, or at least 4 days, or at least 5 days, or at least 6 days, at least 7 days, or at least 8 days, or at least 9 days, or at least 10 days, or at least 11 days, or at least 12 days, at least 13 days, for at least 14 days, or at least 15 days, or at least 16 days, or at least 17 days, or at least 18 days, or at least 19 days, at least 20 days, or at least 21 days, or at least 22 days, or at least 23 days, or at least 24 days, or at least 25 days, at least 26 days, or at least 27 days, or at least 28 days, or at least 29 days, or at least 30 days, or at least 31 days, or at least 45 days, or at least 60 days or at least 75 days or at least 90 days, or at least 4 months, or at least 5 months or at least 6 months or at least 7 months, or at least 8 months, or at least 9 months or at least 10 months or at least 11 months or at least 1 year.

In the methods provided herein to repel and/or kill an insect or bug, the insect or bug can be any targeted insect or bug, such as Siphonaptera insects, such as cat flea (Ctenocephalides felis), dog flea (Ctenocephalides canis), oriental rat flea (Xenopsylla cheopis), human flea (Pulex irritans), chigoe (Tungapenetrans) and European rat flea (Nosopsyllus fasciatus); Anoplura insects, such as Head louse (Pediculus humanus capitis), crab louse (Pthirus pubis), short-nosed cattle louse (Haematopinus eurysternus), sheep louse (Dalmalinia ovis), hog louse (Haematopinus suis), long-nosed cattle louse (Linognathus vituli), cattle biting louse (Bovicola bovis), poultry shaft louse (Menopon gallinae), poultry body louse (Menacanthus stramineus), little blue cattle louse (Solenopotes capillatus), Haematopinus spp., Linognathus spp., Pediculus spp., Phtirus spp. and Solenopotes spp.; Acarina insects, such as bush tick (Haemaphysalis longicomis), Haemaphysalis flava, Dermacentor taiwanicus, American dog tick (Dermacentor variabilis), Ixodes ovatus, Ixodes persulcatus, black legged tick (Ixodes scapularis), lone star tick (Amblyomma americanum), Boophilus microplus, Rhipicephalus sanguineus, Ixodes holocyclus, western black legged tick (Ixodes pacificus), Deer ticks (Ixodes Ricinus), Deer ticks (Ixodes Ricinus), Dermacentor andersoni, Ambryomma maculatum, ear mite (Octodectes cynotis), Psoroptes spp., Chorioptes spp., Otodectes spp., Sarcoptes spp., Notoedres spp., Knemidocoptes spp., Sacroptes scabiei, Demodex spp., follicle mite (Demodex canis), northern fowl mite (Ornithonyssus sylviarum), poultry red mite (Dermanyssus gallinae), Trombicula spp., Leptotrombidium akamushi, Ornithodorus hermsi, Ornithodorus turicata, Ornithonyssus bacoti, Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Cytodites spp. and Laminosioptes spp.; Heteroptera insects, such as common bedbug (Cimex lectularius), tropical bedbug (Cimex hemipterus), Reduvius senilis, Triatoma spp. Rhodnius spp., Panstrongylus spp., and Arilus critatus; and Mallophage (Amblycera and Ischnocera) insects, such as Trimenopon spp., Menopon spp., Trinoton spp., Bovicola spp., Werneckiella spp., Lepikentron spp., Trichodectes spp. and Felicola spp. In particular, provided are methods to repel and/or kill an insect selected from among ants, bedbugs, carpet beetles, centipedes, chiggers, drain flies, dust mites, earwigs, fleas, flies, gnats, hornets, lice, millipedes, mites, mosquitoes, roaches, scabies, silverfish, spiders, stinkbugs, termites, ticks, wasps, weevils and yellow jackets.

In the methods provided, the composition can be deployed by applying it topically to an article of clothing of a human; or applying it topically to skin or hair of a human; or applying it topically to skin or fur of an animal. In the methods provided, the animal can be any animal, such as a bovine, canine, caprine, cervine, cricetine, feline, galline, equine, lapine, murine, musteline and ovine. The animal can be a human or a companion animal. In the methods provided, the nootkatone-containing composition provided herein can be deployed by laundering an article of clothing of a human with a detergent or fabric softener or both that contains the composition; or by drying an article of clothing of a human with a fabric softener that contains the composition. The composition can be deployed by applying to bedding (sheets, blankets, linens, pillows), bed boards, bed slats, a mattress, box springs, furniture, carpeting, baseboards or flooring or a combination thereof. The composition can be deployed by spraying the composition on to the surface of bedding, bed boards, bed slats, a mattress, box springs, furniture or carpeting; or injecting the composition into the pillow, mattress, box springs, furniture or carpeting or a combination thereof; or deploying an absorbent substrate or gel containing the composition in the vicinity of bed boards, bed slats, a mattress, box springs, furniture or carpeting so that vapors from the composition come into contact with a surface of the bed boards, bed slats, a mattress, box springs, furniture or carpeting; or injecting the composition into a wall space.

Also provided are methods of preventing skin injury due to biting insects or bugs, where the methods include providing a composition provided herein; and applying the composition to a surface, wherein the insect or bug is repelled from the surface when it comes into contact with the composition or with vapors from the composition. The composition can be applied to the surface by atomizing, coating, dipping, drenching, dripping, dusting, foaming, infusing, injecting into or onto, pouring, rolling on, scattering, spraying, spreading, sprinkling or wiping an amount of the composition onto the surface. In some methods the surface is bedding (sheets, linens, blankets, pillows), clothing or a mattress. In some methods, the composition can be applied by washing the clothing or bedding with a composition provided herein that is provided as a detergent product or a fabric softener product or both or by drying the clothing or bedding with a composition provided herein that is provided as a fabric softener product. In some methods, the composition can be applied by atomizing, coating, dipping, drenching, dripping, dusting, foaming, infusing, injecting into or onto, pouring, rolling on, scattering, spraying, spreading, sprinkling or wiping the composition onto the surface.

The composition can be provided in a form selected from among skin conditioners, hand/body/facial lotions, skin moisturizers, skin toners, skin sanitizers, skin cleansing compositions, skin soothing and lubricating compositions, sunscreen products, anti-aging products, tanning products, self-tanning products, after-sun products, masking products, antiwrinkle products, hair conditioners, hair styling gels, hair anti-dandruff compositions, hair growth promoter compositions, hair lotions, hair tonics, rinses, conditioners, hair colorant compositions, hair anti-frizzing agent compositions, hair shining compositions, mousses, styling gels, hair pomade products and hair sprays, soaps, foaming bath products, hand/body/facial cleansers, astringent cleansers, anti-acne products, shampoos, body shampoos, synthetic detergent bars, shower gels and shampoos. Particular insects or bugs that are to be repelled and/or killed include ants, bedbugs, chiggers, fleas, lice, mites, mosquitoes, roaches, scabies, and ticks.

Also provided are methods for treating a subject infested with an insect or bug, where the methods include providing any one or more of the compositions provided herein; and applying the composition to a surface of the subject, wherein the insect or bug is repelled from the surface or killed when it comes into contact with the composition or with vapors from the composition. The subject can be an animal, such as a human or a companion animal. The composition is applied to the skin, hair or fur to kill or repel chiggers, fleas, lice, mites, mosquitoes, roaches and scabies.

Use of insect/bug repellent compositions provided herein containing about 0.1 wt % to about 10 wt %, or greater than 10 wt %, or greater than 15 wt %, or greater than 20 wt %, or greater than 25 wt % nootkatone and/or a derivative or analog of nootkatone by weight of the composition for treating a subject infested with an insect or pest can result in 100% knockdown on contact or within 1, 5, 15, 30, or 60 minutes of contact. For some insects or bugs, the compositions provided herein can result in 90%, 95%, 99%, or 100% mortality or the insect or bug. In some applications, the mortality occurs within 5 minutes of application, or within 10 minutes, 15 minutes, 30 minutes, 1 hour, within 2 hours, 3 hours, 4 hours, 5 hours, 6 hours, 7 hours, 8 hours, 8 hours, 10 hours, 11 hours, 12 hours, 13 hours, 14 hours, 15 hours, 16 hours, 17 hours, 18 hours, 19 hours, 20 hours, 21 hours, 22 hours, 23 hours, or 24 hours of applications.

In the methods provided herein, the composition containing about 0.1 wt % to about 10 wt %, or greater than 10 wt %, or greater than 15 wt %, or greater than 20 wt %, or greater than 25 wt % nootkatone and/or a derivative or analog of nootkatone by weight of the composition can be applied to the subject for a time sufficient to repel and/or kill the insects or bugs. The amount of time to kill an insect or bug is dependent on the targeted insect or pest, but generally application to the infested area can be for 8 hours or less, such as for at or about 1, 2, 3, 4, 5, 6, 7, or 8 hours. In some methods, the composition is applied for about 30 minutes or less, such as for about 20 minutes, or 15 minutes, or 10 minutes or 5 minutes. In some methods, the composition can be applied more than once, if required. In some methods, the composition can be applied periodically as a preventative, such as every week, every two weeks, every month or every other month.

The present composition may be used to repel the bug or insect, cause knock-down of the bug or insect, paralyzes the bug or insect, inactivate or immobilize the bug or insect, kills the bug or insect, or cause a lack of progression into at least one stage of the life cycle of the bug or insect.

In one particular embodiment, the present disclosure relates to a method of repelling a tick from attaching to human skin, the method comprises applying a composition to a surface of the human skin, wherein the composition consists essentially of: from about 3 wt % to about 7 wt % of nootkatone; from about 4 wt % to about 12 wt % of benzyl alcohol; from about 1 wt % to about 5 wt % of poly(vinyl pyrrolidone); and from about 76 wt % to about 92 wt % of isopropyl alcohol. Non-limiting examples of ticks include tick (Haemaphysalis longicomis), American dog tick (Dermacentor variabilis), black legged tick (Ixodes scapularis), lone star tick (Amblyomma americanum), Boophilus microplus, western black legged tick (Ixodes pacificus), Deer ticks (Ixodes Ricinus).

### EXAMPLES

Certain embodiments of the present disclosure are further described with reference to the following experiments and examples. These experiments, examples, and samples are intended to be merely illustrative of the disclosure and are not intended to limit or restrict the scope of the present disclosure in any way and should not be construed as providing conditions, parameters, reagents, or starting materials that must be utilized exclusively in order to practice the art of the present disclosure.

### Efficacy of Insect Repellent Compositions—Nootkatone-Containing Formulations Against Ticks Applied on Human Skin

### Objective

The objective of the study was estimate the complete protection time (CPT) of the various repellent formulations against ticks. Complete protection time (CPT) was measured as the length of time from initial application to the First Confirmed Crossing (FCC).

### Experimental Section

### Methods, Materials, Systems, and Conditions

Selected chemicals used in the experiments are described in Table 1. Equipment, instrument, and consumable used in the experiments include analytical weighing balance, stop watch, thermo hygrometer, humidifier, heater, fan, hand gloves, masks, recovery jar, glass vial, paint brush, Whatman™ filter paper, micro pipette, forceps, and petri plate. Deer ticks (Ixodes Ricinus) used in the experiments are described in Table 2. Test conditions are described in Table 3, and details of test design are described in Table 4.

TABLE 1
Selected chemicals used in the present Examples.

| | | |
|---|---|---|
| Material | Nootkatone: A natural | 20% DEET (positive |
| | flavoring agent (test | control) |
| | item) | |
| ISO Common | Nootkatone | DEET |
| name | | |
| IUPAC name | (4R, 4aS, 6R)-6- | N, N-diethyl-m-toluamide |
| | Isoprenyl-4, 4a-dimethyl- | |
| | 4, 4a, 5, 6, 7, 8- | |
| | hexahydro-2(3H)- | |
| | naphthalenone | |
| CAS NO. | 4674-50-4 | 134-62-3 |
| Storage | At room temperature or | Room temperature |
| Conditions | at or about below 8° C. | |

TABLE 2
Details of the test system

| | |
|---|---|
| Test species | Deer Ticks, Ixodes ricinus |
| Age of ticks | Adults |
| Source | Field collected and acclimatized under lab conditions for at |
| | 2 days prior of the experiments in a glass vials. |

TABLE 3
Details of test conditions

| | | Relative | |
|---|---|---|---|
| Parameter | Temperature | humidity | Photoperiod |
| During acclimatization | 25° ± 3° C. | >90% | Approximately 16:8 |
| | | | hours (light:dark) |
| During filter paper | 27 ± 2° C. | 70 ± 20% | Indirect ambient light |
| cylindrical test | | | 50 to 80%. Lights kept |
| experiment | | | on during the |
| During efficacy | | | experiment. |
| experiment | | | |
| using human | | | |
| volunteers | | | |

TABLE 4
Details of test design

| | |
|---|---|
| Number of | 9 (8 with different Nootkatone-containing formulations |
| Treatments | and 1 with DEET) |
| Application | 1 mL/600 cm² of forearm skin area |
| rate | |
| Number of | 32 (16 males + 16 females) |
| Volunteers | Additional 2 volunteers (1 Male + 1 Female) were taken |
| | as alternate |

### Screening Test (Filter Paper Cylindrical Test)

Formulation of Nootkatone were prepared in house. Vertical filter paper method based on the tendency of host seeking ticks to climb was executed to screen the formulation showing >50% repellency. A 4×7 cm rectangle of Whatman™ NO. 4 filter paper was taken and about 90% of the way from one end, a line was marked circumferentially using a pencil. The filter paper was rolled into a hollow cylinder about the diameter of a pointer finger. Different formulation of Nootkatone about 150 μL prepared were eventually applied by the micropipette to the cylinder. The strip was allowed to air dry for 10-15 minutes or the test item to fully absorb. The cylindrical strip with the marker line towards the upper side was placed with finger inside the hollow space in the center of the petri plate and tick was released at the base of the cylinder. The starved ticks were oriented gently to locomote toward the cylindrical strip at upward direction.

Time (minutes) required to for a tick to crawl up the cylinder and cross the 90% line was recorded by using a stop watch. Observation was taken up to 3 minutes. Any tick that crossed the line were nudged back to the base of the filter paper cylindrical base. Formulation showing good efficacy were selected to perform the efficacy of Nootkatone formulations on human skin (Forearm).

### Screening Test (Petri Plate Test)

Whatman™ filter paper of diameter 6 cm was taken and was cut into two equal halves. One half of the filter paper was treated with formulation of Nootkatone with 150 μL and was air dried. Both untreated and treated halves were stick together and placed in a petri plate. About 5 ticks were placed inside the petri plate at the center and the petri plate was covered. Numbers of ticks in control half or treated half were observed at 5 minutes interval up to 30 minutes and thereafter at 1, 2, 4, 6, and 24 hours after releasing the ticks in petri plate. Average % repellency over control was calculated.

Based Filter paper cylindrical test and Petri plate test, Nootkatone-containing formulations showing effective results were considered and further studies against human volunteer was conducted.

### Efficacy Study of the Present Nootkatone-Formulations on Human Skin

A number of 32 volunteers were selected based on signing of informed consent form and passing the sensitivity test, 24-48 hours before the initiation of the experiment. The volunteers were briefed about the experiment in detail prior to signing the consent form. Test volunteers were instructed to avoid alcohol, tobacco, caffeine, and fragrance products (e.g., perfume, cologne, hair spray, lotion, etc.) at least for 12 hours before, and during the test.

A patch test was be conducted on each volunteer to assess sensitivity of the product. Before application of the test product on volunteers arm, the test substance was be applied on 1 cm² marked area of the forearm. Volunteer were observed for 24 hours for all probable signs and symptoms of allergic reaction. No subject/volunteer reported any allergic symptoms and hence were allowed to participate in the study.

For each day of testing, two test subjects, one male and one female, were randomly assigned as alternates. Alternates are used/replaced in the event if the volunteer is absent, chooses to withdraw, or a treated subject gets over-treated during the application process. In the present study, alternate were not used and they were excused for the day and paid for the hours they were at the laboratory.

### Measurement of the Surface Area of the Skin for Test Item Positive Control Application

The test substance/positive control (liquid) was applied at 1 ml/600 cm²±10% deviation. Each repellent formulation was applied evenly over the total surface area (A) around the forearm from 2^{nd} dot (boundary line) to elbow. The treatment area was calculated by measuring the circumference (cm) of the wrist (B), the circumference (cm) at the elbow-cubital fossa (C) when the arm is extended, and the distance (cm) from the elbow to the wrist (D) The surface area (in cm²) of skin was calculated by:

$$Area = 1 / 2 ( {C}_{w} + {C}_{e} ) {D}_{we} ,$$

Where C_{w} is the circumference of the wrist in cm, Cₑ is the elbow cubital fossa circumference in cm, and D_{we} is the distance in cm between C_{w} and Cₑ.

Teat item formulation showing repellency during the cylindrical test were considered. 2 volunteers (1 male and 1 female) each were assigned for selected formulation. One forearm of the volunteer was treated with a test item.

Twelve volunteers were selected for treatment with positive control. One untreated forearm of the control subject (male or female) served as the negative control.

### Tick Screening for Active Foraging and Repellency Challenge

Three “orientation” ink dots were arrayed longitudinally on both ventral forearms of each volunteer, at 3 cm intervals starting from wrist.

On the treated forearm, the first dot (release point) was 3 cm distal to the treated area, the second dot (boundary line) marked the threshold of the treated area, and the third dot was 3 cm into the treated area.

The untreated forearm has a spatially identical array of 3 lines for tick activity screening. Forearms were held from approximately 30° to vertically above the lab bench surface to increases the propensity of ticks to travel toward the body. Ticks were placed on the ventral arm in the most hair-free portion, at the first (most distal line), second dot served to keep the volunteers aware of the beginning of treated area. Every 30 minutes, an unused tick was selected and screened on untreated forearm for active questing behavior, and was repeated until an actively questing tick was identified. Tick was then transferred to the treated arm for a repellent challenge.

With a suitable instrument (artist's paintbrush/forceps) tick was placed, one at a time, on the subject's wrist on the ventral arm in the most hair-free portion, at a release point marked 3 cm below the boundary of the treated area of the forearm. Second dot served to keep the volunteers aware of the beginning of treated area. The tick was oriented gently to locomote toward the margin of the treated area. After its first movement up the arm toward the margin of the treated area, each tick were allowed 3 minutes to move across the boundary onto the treated area. A tick that crossed at least 3 cm into the treated area (toward the elbow) were reported as “not repelled.” “Crossing” is recorded if the test organism crosses the boundary line at least 3 cm into the treated area within 3 minutes, and remains in the treated area for at least one minute.

One that does not cross into the treated area, or that crawls into the treated area but immediately turns back or falls off, is reported as “repelled.”

Fresh ticks were exposed to the treated area one at a time, at regular intervals of 30 minutes until the first crossing or observation were recorded as “not repelled.” The cycle continues until efficacy failure or the end of the study, whichever occurs first.

Active questing was verified if a tick travels past the second marker dot in motion towards the elbow on the untreated arm. A tick or chigger that moves steadily from the release line across the boundary line and upward along the subject's untreated forearm is actively questing, and appropriate for use in repellence testing.

### Observation—Repellency Data Collection and Tick Removal

Time shall be monitored by referring to a timer. Any crossings or repulsions occurred was recorded. Repulsions are normally unambiguous reversals of direction. Tick were lifted off with the paintbrush after each assessment was complete. Any brushes that come into contact with a test material were not reused. Used ticks were immediately transferred post the study to a container labeled as “used”. In repellency testing with ticks or chiggers the appropriate event to show failure of repellent efficacy is a “crossing” from untreated skin onto treated skin.

### Analysis

The Complete Protection time (CPT) was calculated using excel sheet software. For each treated volunteer, measurements were taken as minutes to First Confirmed Crossing (FCC) and Complete Protection Time (CPT)—time between application and FCC. Complete protection time (CPT) was measured as the length of time from initial application to the First Confirmed Crossing (FCC).

### Results and Discussion

Various samples of nootkatone-containing formulations, comparative samples, and the control samples were prepared according to Table 5. The samples were subjected to the cylinder repellency test and the Petri plate repellency test, respectively, and the results were summarized in Table 5. Selected compositions that were shown to have good performance in the cylinder repellency test and in the Petri plate repellency test were subjected to an extended formulation and repellency study on human forearm skin according to Table 6.

TABLE 5
Summary of the screening tests of various sample formulations.

| | | | | | Repellency in |
|---|---|---|---|---|---|
| | | 2 Human volunteers | | Repellency in | Petri plate Test |
| | | tests (CPT in | | cylinder tests | (% repellency |
| Sample ID | Composition | hours/minutes) | | (minutes) | over control) |
| Sample 1 | 3% Nootkatone in IPA | 1.75 | hours | 2.25 | 66.01 |
| Sample 2 | 4% Nootkatone in IPA | 2 hours 15 minutes | | N/A | N/A |
| Sample 3 | 5% Nootkatone in IPA | 2 hours 30 minutes | | N/A | 75.53 |
| Sample 4 | 6% Nootkatone in IPA | 3 hours 15 minutes | | N/A | N/A |
| Comparative | 5% PMD in IPA | 4 hours 15 minutes | | N/A | N/A |
| sample 1 | | | | | |
| Comparative | 100% IPA | 0.00 | | 1.500 | 0.000 |
| sample 2 | | | | | |
| Comparative | 3% dimethyl phthalate | 30 | min | N/A | N/A |
| sample 3 | | | | | |
| Comparative | 5% clove in IPA | N/A | | 2.250 | N/A |
| sample 4 | | | | | |
| Sample 5 | 3% clove + 3% | N/A | | 3.500 | N/A |
| | Nootkatone in IPA | | | | |
| Sample 6 | 5% Thyme in IPA | N/A | | 3.000 | N/A |
| Sample 7 | 5% thyme + 3% | N/A | | 4.875 | N/A |
| | Nootkatone in IPA | | | | |
| Sample 8 | 5% PMD in IPA | 4 hours 15 minutes | | 6.000 | 97.083 |
| Sample 9 | 5% PMD + 3% | 6 hours 15 minutes | | 6.000 | 90.659 |
| | Nootkatone in IPA | | | | |
| Sample 10 | 3% PMD + 3% Thyme + | N/A | | 5.167 | 88.183 |
| | 3% Nootkatone in IPA | | | | |
| Sample 11 | 5% Nootkatone in IPA | N/A | | 5.167 | N/A |
| Sample 12 | 5% Nootkatone + 3% | 4 hours 45 minutes | | 6.000 | 95.052 |
| | Dimethyl Phthalate in IPA | | | | |
| Sample 13 | 3% Nootkatone + 5% | N/A | | 4.833 | N/A |
| | Dimethyl Phthalate in IPA | | | | |
| Comparative | 3% Dimethyl Phthalate in | 30 | minutes | 0 | 4.833 |
| sample 5 | IPA | | | | |
| Comparative | 6% Dimethyl Phthalate in | 30 | minutes | 0.5 | 6.000 |
| sample 6 | IPA | | | | |
| Comparative | 9% Dimethyl Phthalate in | 45 | minutes | N/A | N/A |
| sample 7 | IPA | | | | |
| Control 1 | DEET 20% | 5 hours 15 minutes | | N/A | 98.080 |
| Sample 14 | 5% PMD + 3% | 6 hours 15 minutes | | N/A | N/A |
| | Nootkatone in IPA | | | | |
| Sample 15 | 5% Nootkatone + 3% | 5 hours 45 minutes | | N/A | N/A |
| | Diethyl Phthalate in IPA | | | | |
| Sample 16 | 5% Nootkatone + 6% | 5 hours 45 minutes | | N/A | N/A |
| | Diethyl Phthalate in IPA | | | | |
| Sample 17 | 5% Nootkatone + 3% | 5 | hours | N/A | N/A |
| | Butyl Phthalate in IPA | | | | |
| Sample 18 | 5% PMD + 5% vanillin + | 6 | hours | N/A | N/A |

| | | | | |
|---|---|---|---|---|
| | 3% Nootkatone in IPA | | | |
| Comparative | 5% Eugenol + 3% Diethyl | 4 hours 30 minutes | N/A | 81.36 |
| sample 8 | Phthalate in IPA | | | |
| Comparative | 5% Citral + 3% Diethyl | 3 hours 45 minutes | N/A | 77.51 |
| sample 9 | Phthalate in IPA | | | |
| Comparative | 5% linalool + 3% Diethyl | 4 hours 30 minutes | N/A | 78.34 |
| sample 10 | Phthalate in IPA | | | |
| Comparative | 5% terpene oil + 3% | 3 hours 15 minutes | N/A | 65.97 |
| sample 11 | Diethyl Phthalate in IPA | | | |
| Comparative | 5% cuminaldehyde + 3% | 3 hours, 30 minutes | N/A | 86.97 |
| sample 12 | Diethyl Phthalate in IPA | | | |
| Sample 19 | 5% Eugenol + 3% | 3 hours 45 minutes | N/A | 88.05 |
| | Nootkatone in IPA | | | |
| Sample 20 | 5% Citral + 3% | 3 hours 45 minutes | N/A | 87.75 |
| | Nootkatone in IPA | | | |
| Sample 21 | 5% linalool + 3% | 1 hour 30 minutes | N/A | 89.06 |
| | Nootkatone in IPA | | | |
| Sample 22 | 5% cuminaldehyde + 3% | 2 hours 30 minutes | N/A | 80.22 |
| | Nootkatone in IPA | | | |
| Sample 23 | 5% PMD + 3% | 3 hours 15 minutes | N/A | 84.27 |
| | Nootkatone in IPA | | | |
| Sample 24 | 5% Citral + 5% Eugenol + | 5 hours 15 minutes | N/A | 53.503 |
| | 3% Nootkatone in IPA | | | |
| Sample 25 | 5% PMD + 5% Eugenol + | 4 hours 15 minutes | N/A | 60.305 |
| | 3% Nootkatone in IPA | | | |
| Sample 26 | 5% PMD + 5% Citral + | 3 hours 30 minutes | N/A | 64.507 |
| | 3% Nootkatone in IPA | | | |
| Sample 27 | 5% benzyl alcohol + 3% | 3 hours 30 minutes | N/A | 82.970 |
| | Nootkatone in IPA | | | |
| Sample 28 | 10% benzyl alcohol + 3% | 3 hours 50 minutes | N/A | N/A |
| | Nootkatone in IPA | | | |
| Sample 29 | 3% Nootkatone + 1% | 2 hours 15 minutes | N/A | N/A |
| | PVP in IPA | | | |
| Sample 30 | 3% Nootkatone + 2% | 2 hours 45 minutes | N/A | N/A |
| | PVP in IPA | | | |
| Sample 31 | 5% Nootkatone + 2% | 3 hours 45 minutes | N/A | N/A |
| | PVP in IPA | | | |
| Control 2 | 20% DEET | 6 hours 15 minutes | N/A | N/A |

TABLE 6
Summary of formulations and results for human skin test.

| | | 4 human volunteers (CPT | 12 human volunteers |
|---|---|---|---|
| Sample ID | Composition | in hours) | (CPT in hours) |
| Sample 32 | 3% PMD + 3% Thyme + 3% | 8 hours 15 minutes | N/A |
| | Nootkatone in IPA | | |
| Sample 33 | 5% PMD + 3% Nootkatone | 3 hours 15 minutes | N/A |
| | +1% PVP in IPA | | |
| Sample 34 | 4% Nootkatone + 5% benzyl | 4 hours | 4 hours 15 minutes |
| | alcohol + 2% PVP in IPA | | |
| Sample 35 | 6% Nootkatone + 5% benzyl | 5 hours | N/A |
| | alcohol + 2% PVP in IPA | | |
| Sample 36 | 8% Nootkatone + 5% benzyl | 5 hours | N/A |
| | alcohol + 2% PVP in IPA | | |
| Sample 37 | 5% Nootkatone + 10% benzyl | 5 hours 45 minutes | N/A |
| | alcohol + 2% PVP in IPA | | |
| Sample 38 | 6% Nootkatone + 10% benzyl | 4 hours 30 minutes | N/A |
| | alcohol + 2% PVP in IPA | | |
| Sample 39 | 7% Nootkatone + 10% benzyl | 4 hours 45 minutes | N/A |
| | alcohol + 2% PVP in IPA | | |
| Sample 40 | 5% Nootkatone + 5% benzyl | 3 hours 20 minutes | 3 hours 30 minutes |
| | alcohol + 2% PVP in IPA | | |
| Sample 41 | 5% Nootkatone + 7% benzyl | 4 hours | N/A |
| | alcohol + 2% PVP in IPA | | |
| Sample 42 | 5% Nootkatone + 10% benzyl | 4 hours 15 minutes | N/A |
| | alcohol + 2% PVP in IPA | | |
| Sample 43 | 6% Nootkatone + 5% benzyl | 6 hours 45 minutes | 6 hours 45 minutes; |
| | alcohol + 2% PVP in IPA | | 7 hours 23 minutes |
| Sample 44 | 6% Nootkatone + 7% benzyl | 6 hours | 6 hours; |
| | alcohol + 2% PVP in IPA | | 7 hours 25 minutes |
| Sample 45 | 20% DEET + 10% benzyl | 6 hour 05 minutes | 6 hours 15 minutes |
| | alcohol + 2% PVP in IPA | | |
| Sample 46 | 5% Nootkatone + 10% benzyl | 7 hour 03 minutes | 6 hour 05 minutes |
| | alcohol + 2% PVP in IPA | | |
| Sample 47 | 6% Nootkatone + 10% benzyl | 7 hours 35 minutes | 7 hours 35 minutes |
| | alcohol + 2% PVP in IPA | | |
| Sample 48 | 3% Nootkatone + 10% benzyl | N/A | 4 hours 30 minutes |
| | alcohol + 2% PVP in IPA | | |
| Sample 49 | 4% Nootkatone + 5% benzyl | N/A | 5 hours 15 minutes |
| | alcohol + 2% PVP in IPA | | |
| Sample 50 | 4% Nootkatone + 7% benzyl | N/A | 6 hours |
| | alcohol + 2% PVP in IPA | | |
| Sample 51 | 4% Nootkatone + 10% benzyl | N/A | 8 hours |
| | alcohol + 2% PVP in IPA | | |
| Sample 52 | 3% Nootkatone + 10% benzyl | N/A | 4 hours 45 minutes |
| | alcohol + 2% PVP in IPA | | |
| Sample 53 | 4% Nootkatone + 10% benzyl | N/A | 7 hours 20 minutes |
| | alcohol + 2% PVP in IPA | | |
| Sample 54 | 2% Nootkatone + 10% benzyl | N/A | 2 hours 20 minutes |
| | alcohol + 2% PVP in IPA | | |
| Sample 55 | 3% Nootkatone + 7% benzyl | 3 hours | N/A |
| | alcohol + 2% PVP in IPA | | |
| Sample 56 | 4% Nootkatone + 10% benzyl | N/A | 7 hours 20 minutes |
| | alcohol + 2% PVP in IPA | | |
| Sample 57 | 5% Nootkatone + 10% benzyl | N/A | 7 hour 03 minutes |
| | alcohol + 2% PVP in IPA | | |
| Sample 58 | 6% Nootkatone + 10% benzyl | N/A | 7 hours 35 minutes |
| | alcohol + 2% PVP in IPA | | |
| Control 3 | 20% DEET | N/A | 6 hours 15 minutes |

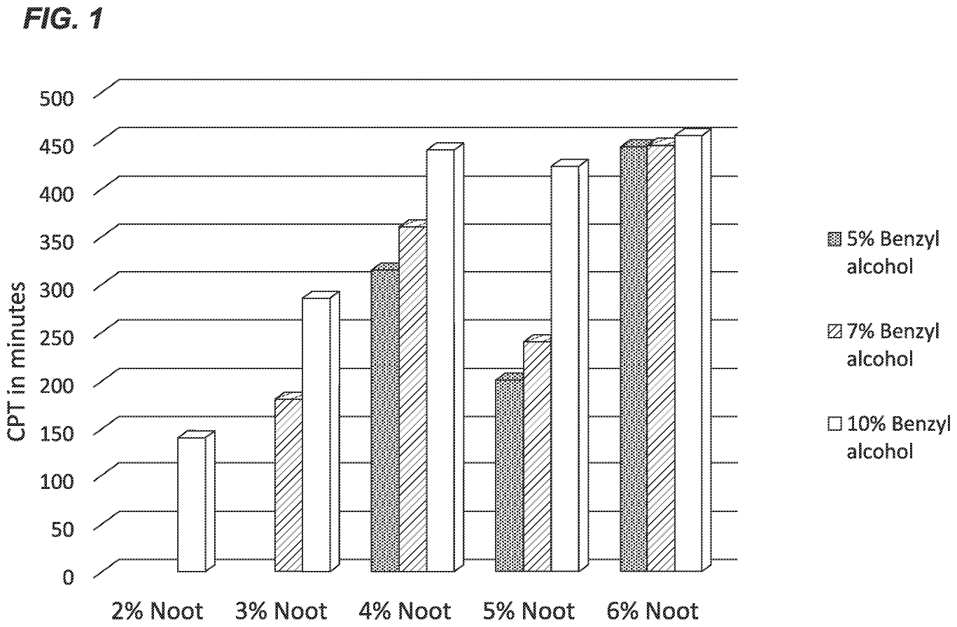

As shown in Table 6, samples compositions comprising Nootkatone, Benzyl alcohol, PVP, and IPA were found to have excellent repellency against ticks on human skin. As shown in FIG. 1, benzyl alcohol was found to effective in prolonging the CPT of the compositions. When the Nootkatone content is of or less than about 5 wt %. Samples having either about 4 wt % or about 6 wt % were shown to have the best performance, with a content of benzyl alcohol of about 5 wt % to about 10 wt %.

A accelerated storage stability study on selected nootkatone-containing formulations were conducted. Freshly prepared samples according to Table 7 were stored at 40° C. for one month. The samples were then subjected to the same human skin test, and the test results were summarized in Table 7.

TABLE 7
Compositions and results of the accelerated storage stability test.

| | | 12 Human volunteers tests |
|---|---|---|
| | | (First Confirmed Crossing |
| | | Time in hours)- Median |
| Sample ID | Composition | protection time |
| Sample 53 | 4% Nootkatone + 10% | 6 hours 15 minutes |
| | Benzyl alcohol + 2% PVP in | |
| | IPA | |
| Sample 43 | 6% Nootkatone + 5% Benzyl | 7 hours |
| | alcohol + 2% PVP in IPA | |
| Control 3 | 20% DEET | 6 hours 15 minutes |

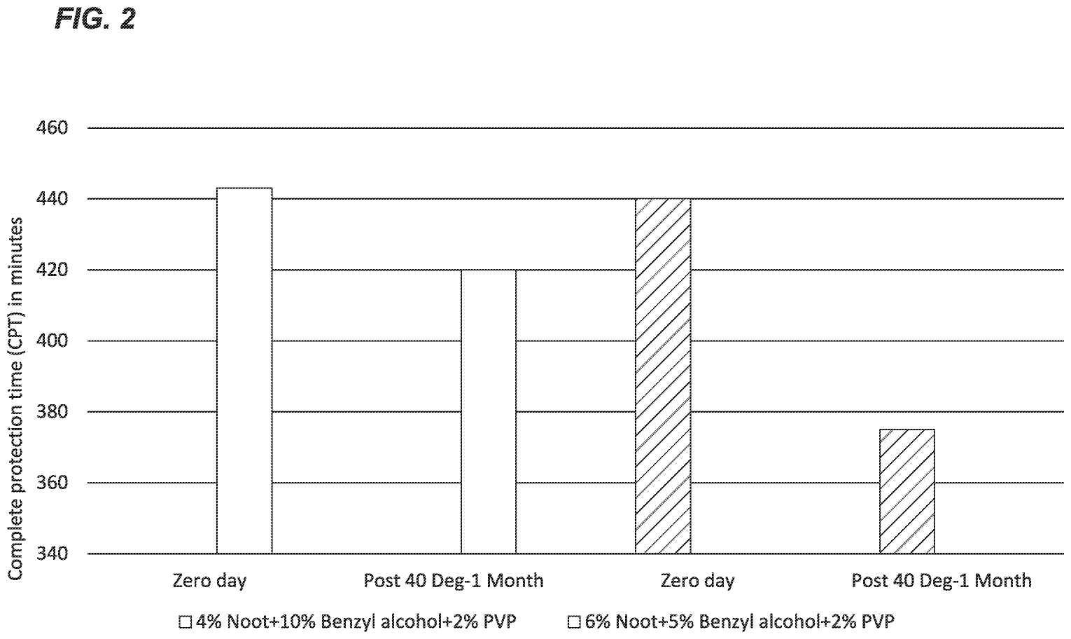

As demonstrated from the above results, nootkatone-containing formulations were shown to have generally good repellency against ticks. As further illustrated in FIG. 2, Sample 53 (4% Nootkatone+10% Benzyl alcohol+2% PVP in IPA) and Sample 43 (6% Nootkatone+5% Benzyl alcohol+2% PVP in IPA) was found to have a CPT 7 hours 20 minutes and 7 hours 23 minutes respectively, on zero day (before storing the samples at 40° C. for one month), and 6 hours 15 minutes and 7 hours respectively after completion of accelerated storage stability test. In comparison, the average complete protection time observed for 20% DEET (control sample) was 375 minutes (6 hours and 15 minutes) before and after storage stability studies. The above results confirmed that the formulations consisting essentially of Nootkatone, Benzyl alcohol, PVP, and IPA are effective and efficient in repelling ticks and have excellent storage stability.

The above specification, examples and data provide a complete description of the manufacture and use of the composition of the disclosure. Since many embodiments of the disclosure can be made without departing from the spirit and scope of the disclosure, the disclosure resides in the claims hereinafter appended.

1. A bug or insect repellent composition, comprising:
nootkatone or an analogue or derivative thereof; and
a carrier.

2. The composition of claim 1, further comprising a dispersing agent.

3. The composition of claim 2, wherein the dispersing agent is selected from the group comprising polycarboxylate, soil release polymer, carboxymethylcelluloses, poly (ethylene glycol), poly(vinylpyridine-N-oxide), poly(vinylimidazole), poly(vinyl pyrrolidone), polyacrylate, poly(acrylic acid), poly(ethylene glycol), poly(vinyl acetate), poly(ethylene glycol)-poly(vinyl acetate), polyacrylate carboxylate copolymer, styrene acrylic acid copolymer, alkyl-polyglucoside, zwitterionic ethoxylated quaternized sulfated hexamethylene diamine, alkoxylated polyalkylenimine, ethoxylated polyamine, and combinations thereof in any proportion.

4. The composition of claim 1, further comprising a solvent.

5. The composition of claim 4, wherein the solvent is selected from the group comprising a polyol, an aromatic alcohol, propylene glycol, hexylene glycol, butanediol, diethylene glycol, benzyl alcohol, terpenoid or derivatives thereof, terpene-ol, terpene-diol, phthalate ester, dimethyl phthalate, diethyl phthalate, butyl phthalate, dioxolane, dimethylformanide, dimethyl solfoxide (DMSO), methyl dodecyl sulfoxide, ethyl oleate, ethyl caprylate, diisopropyl adipate, dimethylacetamide, N-methylpyrrolidone, N-hydroxyethylpyrrolidone, dimethylacetamide, azone (1-dodecylazacycloheptan-2-one), 2-(n-nonyl)-1,3-dioxolane, an isosorbide derivative, dimethyl isosorbide, glycofurol, ethoxydiglycol (transcutol), and combinations thereof in any proportion.

6. The composition of claim 1, wherein the carrier is an alcohol selected from the group comprising monoglyceride, diglyceride, acetylated monoglyceride, triglyceride, 1-propanol, 2-propanol, 1-butanol, 2-butanol, 2-methyl-1-propanol, 1-pentanol, 2-pentanol, 3-methyl-1-butanol, 3-methyl-2-butanol, ethylene glycol, propylene glycol, 1,4-butanediol, 1,3-butanediol, 2-methyl-1,3-propanediol, 1,4-cyclohexanedimethanol, diethylene glycol, triethylene glycol, PEG-200, PEG-300, PEG-400, PEG-600, 2-methoxyethanol, 2-ethoxyethanol, 2-propoxyethanol, 2-isopropoxyethanol, 2-butoxyethanol, 1-methoxy-2-propanol. 1-ethoxy-2-propanol, 3-methoxy-1-butanol, diethylene glycol monomethyl ether, diethylene glycol monoethyl ether, diethylene glycol mono-n-propyl ether, diethylene glycol mono-isopropyl ether, diethylene glycol monobutyl ether, triethylene glycol monomethyl ether, glycerol, octyl alcohol, decyl alcohol, tetrahydrofurfuryl alcohol, 3-methoxy-1,2-propanediol, or 3-ethoxy-1,2-propanediol, N-methyl pyrrolidone, g-butyrolactone, dipropylene glycol monomethyl ether, and combinations thereof in any proportion.

7. The composition of claim 1, further comprising an essential oil compound selected from the group comprising aldehyde C16 (pure), a-terpineol, amyl cinnamic aldehyde, amyl salicylate, anisic aldehyde, benzyl alcohol, benzyl acetate, cuminaldehyde, cinnamaldehyde, cinnamic alcohol, carvacrol, carveol, citral, citronellal, citronellol, p-cymene, diethyl phthalate, dimethyl salicylate, dipropylene glycol, eucalyptol (cineole) eugenol, iso-eugenol, galaxolide, geraniol, guaiacol, ionone, menthol, methyl salicylate, methyl anthranilate, methyl ionone, methyl salicylate, a-pheliandrene, pennyroyal oil perillaldehyde, 1- or 2-phenyl ethyl alcohol, 1- or 2-phenyl ethyl propionate, piperonal, piperonyl acetate, piperonyl alcohol, D-pulegone, terpinen-4-ol, isopropyl myristate, terpinyl acetate, 4-tert-butylcyclohexyl acetate, thyme oil, thymol, lavender oil, rosemary oil, peppermint oil, neem oil, lemongrass oil, wintergreen oil, clove extract, metabolites of trans-anethole, vanillin, ethyl vanillin, linalool oil, and combinations thereof in any proportion.

8. The composition of claim 1, further comprising a flavor substance selected from the group comprising fruit ester, damascenone, alpha-ionone, beta-ionone, raspberry ketone, 2,5-dimethyl-4-hydroxy-3(2H)-furanone, limonene, linalool, phenylacetaldehyde, 2-phenylethanol, maltol, vanillin, linalool oil, eugenol, 2-methyl-4-propyl-1,3-oxathiane, 3-methylthiohexanol, 4-methyl-4-mercapto-2-pentanone, anethol, anise alcohol, anisaldehyde, guajakol, cinnamyl alcohol, cinnamaldehyde, citral, citronellal, citronellol, nerol, geraniol, ethylvanillin, linalool oil, benzyl alcohol, anisaldehyde, cinnamyl ester, benzyl ester, damascone, diacetyl, dihydrocoumarin, beta-dihydroionone, dimethyl anthranilate, methyl anthranilate, 2(5)-ethyl-5(2)-methyl-4-hydroxy-3(2H)-furanone, ethylmaltol, heliotropin, cis-3-hexenyl ester, ethyl decadienoate, methyl dihydrojasmorvate, methyl cinnamate, ethyl cinnamate, p-mentha-8-thiol-3-one, rose oxide, ketoisophorone, and combinations thereof in any proportion.

9. The composition of claim 1, further comprising an synergist or functional enhancer selected from the group comprising p-menthane-3,8-diol (PMD), vanillin, Eugenol, Citral, linalool, terpene-oil or terpene derivatives, cuminaldehyde, thyme oil, clove oil, oil of Lemon Eucalyptus (OLE), and combinations thereof in any proportion.

10. The composition of claim 1, wherein the composition is non-aqueous or substantially free from water.

11. The composition of claim 1, wherein the composition is substantially free from an emulsifier.

12. The composition of claim 1, wherein the composition is substantially free from N, N-diethyl-m-toluamide (DEET).

13. The composition claim 1, wherein the nootkatone has a content from about 0.1 wt % to about 20 wt %, or from about 1 wt % to about 18 wt %, or from about 2 wt % to about 16 wt %, or from about 3 wt % to about 14 wt %, or from about 4 wt % to about 12 wt %, or from about 5 wt % to about 10 wt %, or from about 6 wt % to about 8 wt %, based on the total weight of the composition.

14. The composition of claim 2, wherein the dispersing agent has a content from about 0.1 wt % to about 10 wt %, or from about 0.5 wt % to about 8 wt %, or from about 1 wt % to about 6 wt %, or from about 1.5 wt % to about 5 wt %, or from about 2 wt % to about 4 wt %.

15. The composition of claim 4, wherein the solvent has a content from about 0.1 wt % to about 20 wt %, or from about 1 wt % to about 12 wt %, or from about 2 wt % to about 8 wt %, or from about 3 wt % to about 7 wt %, or from about 4 wt % to about 6 wt %, based on the total weight of the composition.

16. The composition of claim 7, wherein the essential oil compound has a content from about 0 to about 20 wt %, or from about 1 wt % to about 12 wt %, or from about 2 wt % to about 8 wt %, or from about 3 wt % to about 7 wt %, or from about 4 wt % to about 6 wt %, based on the total weight of the composition.

17. The composition of claim 8, wherein the flavor substance has a content from about 0 wt % to about 20 wt %, or from about 1 wt % to about 12 wt %, or from about 2 wt % to about 8 wt %, or from about 3 wt % to about 7 wt %, or from about 4 wt % to about 6 wt %, based on the total weight of the composition.

18. A bug or insect repellent composition consisting essentially of:
from about 1 wt % to about 10 wt % of nootkatone;
from about 1 wt % to about 20 wt % of a solvent;
from about 1 wt % to about 10 wt % of a dispersing agent; and
from about 60 wt % to about 97 wt % of a carrier.

19. A bug or insect repellent composition consisting essentially of:
from about 1 wt % to about 10 wt % of nootkatone;
from about 1 wt % to about 20 wt % of a solvent;
from about 1 wt % to about 10 wt % of a synergist or functional enhancer; and
from about 60 wt % to about 97 wt % of a carrier.

20. A bug or insect repellent composition consisting essentially of:
from about 1 wt % to about 10 wt % of nootkatone;
from about 1 wt % to about 20 wt % of a solvent;
from about 1 wt % to about 10 wt % of a dispersing agent;
from about 1 wt % to about 10 wt % of an synergist or functional enhancer; and
from about 50 wt % to about 96 wt % of a carrier.

21. The composition of claim 18, wherein the solvent is selected from the group comprising benzyl alcohol, diethyl phthalate, butyl phthalate, and combinations thereof in any proportion.

22. The composition of claim 18, wherein the carrier is selected from the group comprising ethanol, 1-propanol, 2-propanol (isopropyl alcohol), 1-butanol, 2-butanol, 2-methyl-1-propanol, 1-pentanol, 2-pentanol, 3-methyl-1-butanol, 3-methyl-2-butanol, ethylene glycol, propylene glycol, 1,4-butanediol, 1,3-butanediol, octyl alcohol, decyl alcohol, tetrahydrofurfuryl alcohol, N-methyl pyrrolidone, g-butyrolactone, dipropylene glycol monomethyl ether, and combinations thereof in any proportion.

23. The composition of claim 18, wherein the dispersing agent is a polymer selected from the group comprising poly(vinyl pyrrolidone), polyacrylate, poly(acrylic acid), poly(ethylene glycol), poly(vinyl alcohol), poly(vinyl acetate), polyacrylate carboxy late copolymer, styrene acrylic acid copolymer, alkyl-polyglucoside, and combinations thereof in any proportion.

24. The composition of claim 19, wherein the synergist or functional enhancer is selected from the group comprising aldehyde C16 (pure), a-terpineol, amyl cinnamic aldehyde, amyl salicylate, anisic aldehyde, benzyl alcohol, benzyl acetate, cuminaldehyde, cinnamaldehyde, cinnamic alcohol, carvacrol, carveol, citral, citronellal, citronellol, p-cymene, diethyl phthalate, dimethyl salicylate, dipropylene glycol, eucalyptol (cineole) eugenol, iso-eugenol, galaxolide, geraniol, guaiacol, ionone, menthol, methyl salicylate, methyl anthranilate, methyl ionone, methyl salicylate, a-pheliandrene, pennyroyal oil perillaldehyde, 1- or 2-phenyl ethyl alcohol, 1- or 2-phenyl ethyl propionate, piperonal, piperonyl acetate, piperonyl alcohol, D-pulegone, terpinen-4-ol, isopropyl myristate, terpinyl acetate, 4-tert-butylcyclohexyl acetate, thyme oil, thymol, lavender oil, rosemary oil, peppermint oil, neem oil, lemongrass oil, wintergreen oil, clove extract, metabolites of trans-anethole, vanillin, ethyl vanillin, and combinations thereof in any proportion.

25. A bug or insect repellent composition consisting essentially of:
from about 3 wt % to about 7 wt % of nootkatone;
from about 4 wt % to about 12 wt % of benzyl alcohol;
from about 1 wt % to about 5 wt % of poly(vinyl pyrrolidone); and
from about 76 wt % to about 92 wt % of isopropyl alcohol.

26. A method of repelling an insect comprising applying the composition according to claim 1 on a surface, whereby the insect is repelled from attaching to the surface.

27. The method of claim 26, wherein the insect is selected from the group comprising a nematode, a mosquito, a gnat, a horse fly, a tick, a tsetse fly, a blowfly, a screw fly, a bed bug, a flea, a louse, a sea louse, an fish louse, an aphid, a thrip, an arachnid, a termite, a silverfish, an ant, a cockroach, a locust, a fruit fly, a wasp, a hornet, a yellow jacket, a scorpion, a chigger, a mite, or a dust mite.

28. The method of claim 26, wherein the surface is selected from the group comprising a plant, a portion of a plant, a harvested plant material, an exterior surface of a human body, an exterior surface of an animal body, skin, hair, fur, scales, feathers, an article of clothing, a collar, a shoe, furniture, bedding, a net, a table, a bench, a desk, a pathway, a carpet, a floor board, a head board, a curtain, a window sill, a mantelpiece, a work surface, a door, a wall molding, a wall, a sheet of glass, or any surface of a vehicle, a tent, a wall, a floor, a waste bin, or a water surface.

29. The method of claim 26, wherein the composition is applied to the surface by an aerosol container with a spray nozzle, a spray gun, a pump sprayer, a trigger sprayer, a pressurized spraying device, a sponge, a brush, a roller, an irrigation spray, or a crop duster helicopter or airplane.

30. A method of preventing attachment of an insect, the method comprising applying the composition according to claim 1 to a surface, wherein the composition repels the insect, causes knock-down of the insect, paralyzes the insect, kills the insect, or causes a lack of progression into at least one stage of the life cycle of the insect.

31. The method of claim 30, wherein the insect is selected from the group comprising a nematode, a mosquito, a gnat, a horse fly, a tick, a tsetse fly, a blowfly, a screw fly, a bed bug, a flea, a louse, a sea louse, an fish louse, an aphid, a thrip, an arachnid, a termite, a silverfish, an ant, a cockroach, a locust, a fruit fly, a wasp, a hornet, a yellow jacket, a scorpion, a chigger, a mite, or a dust mite.

32. The method of claim 30, wherein the surface is selected from the group comprising a plant, a portion of a plant, a harvested plant material, an exterior surface of a human body, an exterior surface of an animal body, skin, hair, fur, scales, feathers, an article of clothing, a collar, a shoe, furniture, bedding, a net, a table, a bench, a desk, a pathway, a carpet, a floor board, a head board, a curtain, a window sill, a mantelpiece, a work surface, a door, a wall molding, a wall, a sheet of glass, or any surface of a vehicle, a tent, a wall, a floor, a waste bin, or a water surface.

33. The method of claim 30, wherein the composition is applied to the surface by an aerosol container with a spray nozzle, a spray gun, a pump sprayer, a trigger sprayer, a pressurized spraying device, a sponge, a brush, a roller, an irrigation spray, or a crop duster helicopter or airplane.

34. A method of repelling a tick from attaching to human skin, the method comprises applying a composition to a surface of the human skin, wherein the composition consists essentially of:
from about 3 wt % to about 7 wt % of nootkatone;
from about 4 wt % to about 12 wt % of benzyl alcohol;
from about 1 wt % to about 5 wt % of poly(vinyl pyrrolidone); and
from about 76 wt % to about 92 wt % of isopropyl alcohol.

35. The method of claim 34, wherein the composition is applied to the surface by a pressured aerosol container, a non-pressured aerosol container with a spray nozzle, a trigger sprayer, or a pressurized spraying device.
